(19) United States
(12) Patent Application Publication
(10) Pub. No.: US 2012/0027094 A1
(43) Pub. Date: Feb. 2, 2012

(54) IMAGE PROCESSING DEVICE AND METHOD

(76) Inventors: Kazushi Sato, Kanagawa (JP); Yoichi Yagasaki, Tokyo (JP)

(21) Appl. No.: 13/148,629

(22) PCT Filed: Feb. 12, 2010
(86) PCT No.: PCT/JP2010/052019

§ 371 Date: Aug. 9, 2011

(30) Foreign Application Priority Data
Feb. 20, 2009 (JP) 2009-037465

(51) Int. Cl. H04N 7/26

(52) U.S. Cl. 375/240.16; 375/E07.125

(57) ABSTRACT

The present invention relates to an image processing device and method which enable increase in compressed information to be suppressed, and also enable prediction precision to be improved.

An SDM residual energy calculating unit 91 and a TDM residual energy calculating unit 92 calculate residual energy using motion vector information in a spatial direct mode and a temporal direct mode, a encoded peripheral pixel group of an object block, respectively. A comparing unit 93 compares the residual energy in the spatial direct mode and the residual energy in the temporal direct mode. A direct mode determining unit 94 selects smaller residual energy as a result of comparison as the optimal direct mode of the object block. The present invention may be applied to an image encoding device which performs encoding using the H.264/AVC system, for example.

### TECHNICAL FIELD

The present invention relates to an image processing device and method, and specifically relates to an image processing device and method which enable increase in compressed information to be suppressed and also enable prediction precision to be improved.

### BACKGROUND ART

In recent years, devices have come into widespread use which subject an image to compression encoding by employing an encoding system handling image information as digital signals, and at this time compress the image by orthogonal transform such as discrete cosine transform or the like and motion compensation, taking advantage of redundancy which is a feature of the image information, in order to perform highly efficient transmission and accumulation of information. Examples of this encoding method include MPEG (Moving Picture Expert Group) and so forth.

In particular, MPEG2 (ISO/IEC 13818-2) is defined as a general-purpose image encoding system, and is a standard encompassing both of interlaced scanning images and sequential-scanning images, and standard resolution images and high definition images. For example, MPEG2 has widely been employed now by broad range of applications for professional usage and for consumer usage. By employing the MPEG2 compression system, a code amount (bit rate) of 4 through 8 Mbps is allocated in the event of an interlaced scanning image of standard resolution having 720×480 pixels, for example. By employing the MPEG2 compression system, a code amount (bit rate) of 18 through 22 Mbps is allocated in the event of an interlaced scanning image of high resolution having 1920×1088 pixels, for example. Thus, a high compression rate and excellent image quality can be realized.

MPEG2 has principally been aimed at high image quality encoding adapted to broadcasting usage, but does not handle lower code amount (bit rate) than the code amount of MPEG1, i.e., an encoding system having a higher compression rate. It is expected that demand for such an encoding system will increase from now on due to the spread of personal digital assistants, and in response to this, standardization of the MPEG4 encoding system has been performed. With regard to an image encoding system, the specification thereof was confirmed as international standard as ISO/IEC 14496-2 in December in 1998.

Further, in recent years, standardization of a standard called H.26L (ITU-T Q6/16 VCEG) has progressed with image encoding for television conference usage as the object. With H.26L, it has been known that though greater computation amount is requested for encoding and decoding thereof as compared to a conventional encoding system such as MPEG2 or MPEG4, higher encoding efficiency is realized. Also, currently, as part of activity of MPEG4, standardization for taking advantage of a function that is not supported by H.26L with this H.26L taken as base to realize higher encoding efficiency has been performed as Joint Model of Enhanced-Compression Video Coding. As a schedule of standardization, H.264 and MPEG-4 Part10 (Advanced Video Coding, hereafter referred to as H.264/AVC) become an international standard in March, 2003.

Incidentally, with the MPEG2 system, motion prediction and compensation processing with ½ pixel precision has been performed by linear interpolation processing. On the other hand, with the H.264/AVC system, prediction and compensation processing with ¼ pixel precision using 6-tap FIR (Finite Impulse Response Filter) filter has been performed.

With the MPEG2 system, in the event of the frame motion compensation mode, motion prediction and compensation processing is performed in increments of 16×16 pixels. In the event of the field motion compensation mode, motion prediction and compensation processing is performed as to each of the first field and the second field in increments of 16×8 pixels.

On the other hand, with the H.264/AVC system, motion prediction and compensation can be performed with the block size taken as variable. Specifically, with the H.264/AVC system, one macro block made up of 16×16 pixels may be divided into one of the partitions of 16×16, 16×8, 8×16, and 8×8 with each partition having independent motion vector information. Also, an 8×8 partition may be divided into one of the sub-partitions of 8×8, 8×4, 4×8, and 4×4 with each sub-partition having independent motion vector information.

However, with the H.264/AVC system, by motion prediction and compensation processing with ¼ pixel precision and block variable being performed, vast amounts of motion vector information are generated, leading to deterioration in encoding efficiency if these are encoded without change.

Therefore, it has been proposed to suppress deterioration in encoding efficiency by a method for generating the prediction motion vector information of an object block to be encoded from now on using the already encoded motion vector information of an adjacent block by median operation, or the like.

Further, since the information amount of motion vector information in a B picture is vast, an encoding mode called as a direct mode is provided in the H.264/AVC system. This direct mode is an encoding mode for generating motion information from the motion information an encoded block by prediction, and the number of bits necessary for encoding of the motion information is unnecessary, whereby compression encoding can be improved.

The direct mode includes two types of a spatial direct mode (Spatial Direct Mode) and a temporal direct mode (Temporal Direct Mode). The spatial direct mode is a mode for taking advantage of correlation of motion information principally in the spatial direction (horizontal and vertical two-dimensional space within a picture), and the temporal direct mode is a mode for taking advantage of correlation of motion information principally in the temporal direction.

Of these spatial direct mode and temporal direct mode, which is employed can be switched for each slice. Specifically, description is made in “7.3.3. Slice header syntax” in NPL 1 wherein it is specified that, in an object slice, “direct_spatial_mv_pred_flag” specifies which to employ of the spatial direct mode and the temporal direct mode.

### CITATION LIST

### Non Patent Literature

NPL 1: “ITU-T Recommendation H.264 Advanced video coding for generic audiovisual”, November 2007

### SUMMARY OF INVENTION

### Technical Problem

Incidentally, even within the same slice, which of the above-mentioned spatial direct mode and temporal direct mode provides better encoding efficiency differs for each macro block or each block.

However, with the H.264/AVC system, switching of these has been performed only for each slice. Also, if the optimal direct mode is selected for each macro block or each block to be encoded, and information indicating which direct mode is used is transmitted to an image decoding device, this leads to deterioration in encoding efficiency.

The present invention has been made in light of such a situation, which suppresses increase in compressed information and also improves prediction precision.

### Solution to Problem

An image processing device according to a first aspect of the present invention includes: spatial mode residual energy calculating means configured to use motion vector information according to a spatial direct mode of an object block to calculate spatial mode residual energy that employs a peripheral pixel adjacent to the object block in a predetermined positional relation and also included in a decoded image; temporal mode residual energy calculating means configured to use motion vector information according to a temporal direct mode of the object block to calculate temporal mode residual energy that employs the peripheral pixel; and direct mode determining means configured to determine to perform encoding of the object block in the spatial direct mode in the event that the spatial mode residual energy calculated by the spatial mode residual energy calculating means is equal to or smaller than the temporal mode residual energy calculated by the temporal mode residual energy calculating means, and to perform encoding of the object block in the temporal direct mode in the event that the spatial mode residual energy is greater than the temporal mode residual energy.

The image processing device may further include: encoding means configured to encode the object block in accordance with the spatial direct mode or the temporal direct mode determined by the direct mode determining means.

The spatial mode residual energy calculating means may calculate the spatial mode residual energy from a Y signal component, a Cb signal component, and a Cr signal component, the temporal mode residual energy calculating means may calculate the temporal mode residual energy from a Y signal component, a Cb signal component, and a Cr signal component, and the direct mode determining means may compare a magnitude relation between the spatial mode residual energy and the temporal mode residual energy for each of the Y signal component, the Cb signal component, and the Cr signal component to determine whether the object block is encoded in the spatial direct mode or the object block is encoded in the temporal direct mode.

The spatial mode residual energy calculating means may calculate the spatial mode residual energy from a luminance signal component of the object block, and the temporal mode residual energy calculating means may calculate the temporal mode residual energy from a luminance signal component of the object block.

The spatial mode residual energy calculating means may calculate the spatial mode residual energy from a luminance signal component and a color difference signal component of the object block, and the temporal mode residual energy calculating means may calculate the temporal mode residual energy from a luminance signal component and a color difference signal component of the object block.

The image processing device may further include: spatial mode motion vector calculating means configured to calculate motion vector information according to the spatial direct mode; and temporal mode motion vector calculating means configured to calculate motion vector information according to the temporal direct mode.

An image processing method according to a first aspect of the present invention includes the step of: causing an image processing device to use motion vector information according to a spatial direct mode of an object block to calculate spatial mode residual energy that employs a peripheral pixel adjacent to the object block in a predetermined positional relation and also included in a decoded image; to use motion vector information according to a temporal direct mode of the object block to calculate temporal mode residual energy that employs the peripheral pixel; and to determine to perform encoding of the object block in the spatial direct mode in the event that the spatial mode residual energy is equal to or smaller than the temporal mode residual energy, and to perform encoding of the object block in the temporal direct mode in the event that the spatial mode residual energy is greater than the temporal mode residual energy.

An image processing device according to a second aspect of the present invention includes: spatial mode residual energy calculating means configured to use motion vector information according to a spatial direct mode of an object block encoded in a direct mode to calculate spatial mode residual energy that employs a peripheral pixel adjacent to the object block in a predetermined positional relation and also included in a decoded image; temporal mode residual energy calculating means configured to use motion vector information according to a temporal direct mode of the object block to calculate temporal mode residual energy that employs the peripheral pixel; and direct mode determining means configured to determine to perform generation of a prediction image of the object block in the spatial direct mode in the event that the spatial mode residual energy calculated by the spatial mode residual energy calculating means is equal to or smaller than the temporal mode residual energy calculated by the temporal mode residual energy calculating means, and to perform generation of a prediction image of the object block in the temporal direct mode in the event that the spatial mode residual energy is greater than the temporal mode residual energy.

The image processing device may further include: motion compensating means configured to generate a prediction image of the object block in accordance with the spatial direct mode or the temporal direct mode determined by the direct mode determining means.

The spatial mode residual energy calculating means may calculate the spatial mode residual energy from a Y signal component, a Cb signal component, and a Cr signal component, the temporal mode residual energy calculating means may calculate the temporal mode. residual energy from a Y signal component, a Cb signal component, and a Cr signal component, and the direct mode determining means may compare a magnitude relation between the spatial mode residual energy and the temporal mode residual energy for each of the Y signal component, the Cb signal component, and the Cr signal component to determine whether generation of a prediction image of the object block is performed in the spatial direct mode or generation of a prediction image of the object block is performed in the temporal direct mode.

The spatial mode residual energy calculating means may calculate the spatial mode residual energy from a luminance signal component of the object block, and the temporal mode residual energy calculating means may calculate the temporal mode residual energy from a luminance signal component of the object block.

The spatial mode residual energy calculating means may calculate the spatial mode residual energy from a luminance signal component and a color difference signal component of the object block, and the temporal mode residual energy calculating means may calculate the temporal mode residual energy from a luminance signal component and a color difference signal component of the object block.

An image processing method according to the second aspect of the present invention includes the step of: causing an image processing device to use motion vector information according to a spatial direct mode of an object block encoded in a direct mode to calculate spatial mode residual energy that employs a peripheral pixel adjacent to the object block in a predetermined positional relation and also included in a decoded image; to use motion vector information according to a temporal direct mode of the object block to calculate temporal mode residual energy that employs the peripheral pixel; and to determine to perform generation of a prediction image of the object block in the spatial direct mode in the event that the spatial mode residual energy is equal to or smaller than the temporal mode residual energy, and to perform generation of a prediction image of the object block in the temporal direct mode in the event that the spatial mode residual energy is greater than the temporal mode residual energy.

With the first aspect of the present invention, motion vector information according to a spatial direct mode of an object block is used to calculate spatial mode residual energy that employs a peripheral pixel adjacent to the object block in a predetermined positional relation and also included in a decoded image, motion vector information according to a temporal direct mode of the object block is used to calculate temporal mode residual energy that employs the peripheral pixel. Subsequently, in the event that the spatial mode residual energy is equal to or smaller than the temporal mode residual energy, it is determined to perform encoding of the object block in the spatial direct mode, and in the event that the spatial mode residual energy is greater than the temporal mode residual energy, it is determined to perform encoding of the object block in the temporal direct mode.

With the second aspect of the present invention, motion vector information according to a spatial direct mode of an object block encoded in a direct mode is used to calculate spatial mode residual energy that employs a peripheral pixel adjacent to the object block in a predetermined positional relation and also included in a decoded image, and motion vector information according to a temporal direct mode of the object block is used to calculate temporal mode residual energy that employs the peripheral pixel. Subsequently, in the event that the spatial mode residual energy is equal to or smaller than the temporal mode residual energy calculated, it is determined to perform generation of a prediction image of the object block in the spatial direct mode, and in the event that the spatial mode residual energy is greater than the temporal mode residual energy, it is determined to perform generation of a prediction image of the object block in the temporal direct mode.

Note that the above-mentioned image processing devices may be stand-alone devices, or may be internal blocks making up a single image encoding device or image decoding device.

### Advantageous Effects of Invention

According to the first aspect of the present invention, a direct mode for performing encoding of an object block can be determined. Also, according to the first aspect of the present invention, increase in compressed information can be suppressed, and also prediction precision can be improved.

According to the second aspect of the present invention, a direct mode for performing generation of a prediction image of an object block can be determined. Also, according to the second aspect of the present invention, increase in compressed information can be suppressed, and also prediction precision can be improved.

### BRIEF DESCRIPTION OF DRAWINGS

FIG. 1 is a block diagram illustrating a configuration of an embodiment of an image encoding device to which the present invention has been applied.

FIG. 2 is a diagram for describing motion prediction and compensation processing with variable block size.

FIG. 3 is a diagram for describing motion prediction and compensation processing with ¼ pixel precision.

FIG. 4 is a diagram for describing a motion prediction and compensation method of multi-reference frames.

FIG. 5 is a diagram for describing an example of a motion vector information generating method.

FIG. 6 is a block diagram illustrating a configuration example of a direct mode selecting unit.

FIG. 7 is a flowchart for describing the encoding processing of the image encoding device in FIG. 1.

FIG. 8 is a flowchart for describing prediction processing in step S21 in FIG. 7.

FIG. 9 is a flowchart for describing intra prediction processing in step S31 in FIG. 8.

FIG. 10 is a flowchart for describing inter motion prediction processing in step S32 in FIG. 8.

FIG. 11 is a flowchart for describing direct mode prediction processing in step S33 in FIG. 8.

FIG. 12 is a diagram for describing a temporal direct mode.

FIG. 13 is a diagram for describing an example of residual energy calculation.

FIG. 14 is a block diagram illustrating, the configuration of an embodiment of an image decoding device to which the present invention has been applied.

FIG. 15 is a flowchart for describing the decoding processing of the image decoding device in FIG. 14.

FIG. 16 is a flowchart for describing prediction processing in step S138 in FIG. 15.

FIG. 17 is a flowchart for describing inter template motion prediction processing in step S175 in FIG. 16.

FIG. 18 is a diagram illustrating an example of an extended block size.

FIG. 19 is a block diagram illustrating a configuration example of the hardware of a computer.

FIG. 20 is a block diagram illustrating a principal configuration example of a television receiver to which the present invention has been applied.

FIG. 21 is a block diagram illustrating a principal configuration example of a cellular phone to which the present invention has been applied.

FIG. 22 is a block diagram illustrating a principal configuration example of a hard disk recorder to which the present invention has been applied.

FIG. 23 is a block diagram illustrating a principal configuration example of a camera to which the present invention has been applied.

### DESCRIPTION OF EMBODIMENTS

Hereafter, an embodiment of the present invention will be described with reference to the drawings.

Configuration Example of Image Encoding Device

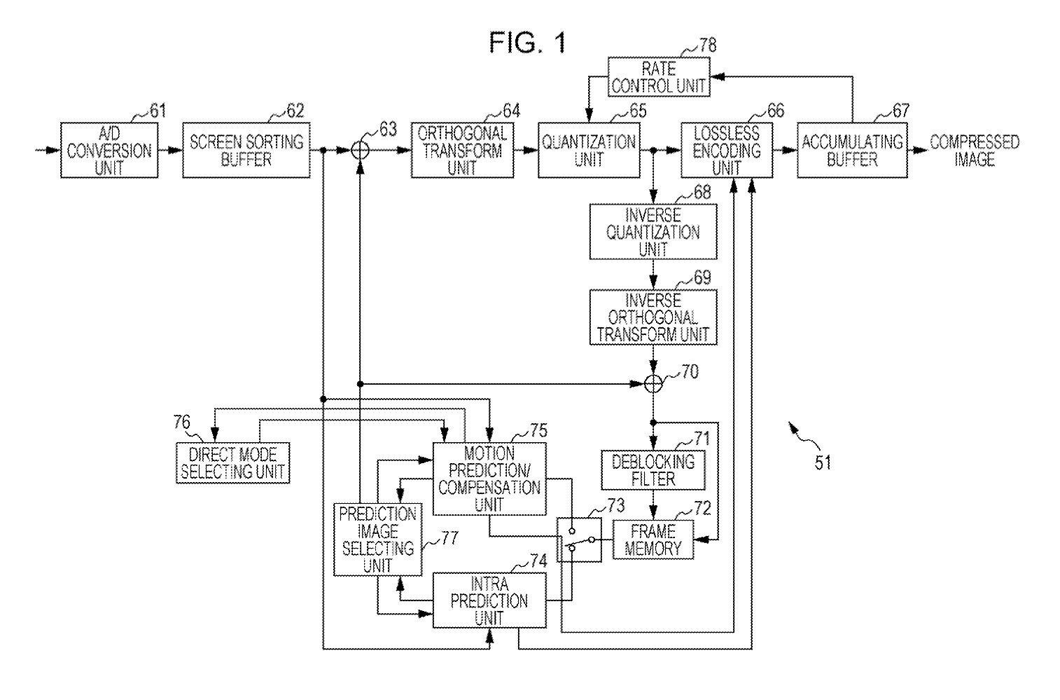

FIG. 1 represents the configuration of an embodiment of an image encoding device serving as an image processing device to which the present invention has been applied.

This image encoding device 51 subjects an image to compression encoding using, for example, the H.264 and MPEG-4 Part10 (Advanced Video Coding) (hereafter, described as 264/AVC) system. Note that encoding in the image encoding device 51 is performed in increments of blocks or macro blocks. Hereafter, in the event of referring to an object block to be encoded, description will be made assuming that a block or macro block is included in the object block.

With the example in FIG. 1, the image encoding device 51 is configured of an A/D conversion unit 61, a screen sorting buffer 62, a computing unit 63, an orthogonal transform unit 64, a quantization unit 65, a lossless encoding unit 66, an accumulating buffer 67, an inverse quantization unit 68, an inverse orthogonal transform unit 69, a computing unit 70, a deblocking filter 71, frame memory 72, a switch 73, an intra prediction unit 74, a motion prediction/compensation unit 75, a direct mode selecting unit 76, a prediction image selecting unit 77, and a rate control unit 78.

The A/D conversion unit 61 converts an input image from analog to digital, and outputs to the screen sorting buffer 62 for storing. The screen sorting buffer 62 sorts the images of frames in the stored order for display into the order of frames for encoding according to GOP (Group of Picture).

The computing unit 63 subtracts from the image read out from the screen sorting buffer 62 the prediction image from the intra prediction unit 74 selected by the prediction image selecting unit 77 or the prediction image from the motion prediction/compensation unit 75, and outputs difference information thereof to the orthogonal transform unit 64. The orthogonal transform unit 64 subjects the difference information from the computing unit 63 to orthogonal transform, such as discrete cosine transform, Karhunen-Loéve transform, or the like, and outputs a transform coefficient thereof. The quantization unit 65 quantizes the transform coefficient that the orthogonal transform unit 64 outputs.

The quantized transform coefficient that is the output of the quantization unit 65 is input to the lossless encoding unit 66, and subjected to lossless encoding, such as variable length coding, arithmetic coding, or the like, and compressed.

The lossless encoding unit 66 obtains information indicating intra prediction from the intra prediction unit 74, and obtains information indicating inter prediction and direct mode, and so forth from the motion prediction/compensation unit 75. Note that, hereafter, the information indicating intra prediction will also be referred to as intra prediction mode information. Also, the information indicating inter prediction and the information indicating the direct mode will also be referred to as inter prediction mode information and direct mode information, respectively.

The lossless encoding unit 66 encodes the quantized transform coefficient, and also encodes the information indicating intra prediction, the information indicating inter prediction and direct mode, and so forth, and takes these as part of header information in the compressed image. The lossless encoding unit 66 supplies the encoded data to the accumulating buffer 67 for accumulation.

For example, with the lossless encoding unit 66, lossless encoding processing, such as variable length coding, arithmetic coding, or the like, is performed. Examples of the variable length coding include CAVLC (Context-Adaptive Variable Length Coding) determined by the H.264/AVC system. Examples of the arithmetic coding include CABAC (Context-Adaptive Binary Arithmetic Coding).

The accumulating buffer 67 outputs the data supplied from the lossless encoding unit 66 to, for example, a downstream storage device or transmission path or the like not shown in the drawing, as a compressed image encoded by the H.264/AVC system.

Also, the quantized transform coefficient output from the quantization unit 65 is also input to the inverse quantization unit 68, subjected to inverse quantization, and then subjected to further inverse orthogonal transform at the inverse orthogonal transform unit 69. The output subjected to inverse orthogonal transform is added to the prediction image supplied from the prediction image selecting unit 77 by the computing unit 70, and changed into a locally decoded image. The deblocking filter 71 removes block distortion from the decoded image, and then supplies to the frame memory 72 for accumulation. An image before the deblocking filter processing is performed by the deblocking filter 71 is also supplied to the frame memory 72 for accumulation.

The switch 73 outputs the reference images accumulated in the frame memory 72 to the motion prediction/compensation unit 75 or intra prediction unit 74.

With this image encoding device 51, the I picture, B picture, and P picture from the screen sorting buffer 62 are supplied to the intra prediction unit 74 as an image to be subjected to intra prediction (also referred to as intra processing), for example. Also, the B picture and P picture read out from the screen sorting buffer 62 are supplied to the motion prediction/compensation unit 75 as an image to be subjected to inter prediction (also referred to as inter processing).

The intra prediction unit 74 performs intra prediction processing of all of the intra prediction modes serving as candidates based on the image to be subjected to intra prediction read out from the screen sorting buffer 62, and the reference image supplied from the frame memory 72 to generate a prediction image.

At this time, the intra prediction unit 74 calculates a cost function value as to all of the intra prediction modes serving as candidates, and selects the intra prediction mode of which the calculated cost function value provides the minimum value, as the optimal intra prediction mode.

The intra prediction unit 74 supplies the prediction image generated in the optimal intra prediction mode, and the cost function value thereof to the prediction image selecting unit 77. In the event that the prediction image generated in the optimal intra prediction mode has been selected by the prediction image selecting unit 77, the intra prediction unit 74 supplies the information indicating the optimal intra prediction mode to the lossless encoding unit 66. The lossless encoding unit 66 encodes this information, and takes this as part of the header information in a compressed image.

The motion prediction/compensation unit 75 performs motion prediction and compensation processing regarding all of the inter prediction modes serving as candidates. Specifically, as to the motion prediction/compensation unit 75, the image to be subjected to inter processing read out from the screen sorting buffer 62 is supplied and the reference image is supplied from the frame memory 72 via the switch 73. The motion prediction/compensation unit 75 detects the motion vectors of all of the inter prediction modes serving as candidates based on the image to be subjected to inter processing and the reference image, subjects the reference image to compensation processing based on the motion vectors, and generates a prediction image.

Note that the motion prediction/compensation unit 75 subjects a B picture to the motion prediction and compensation processing based on the image to be subjected to inter processing and the reference image, and based on the direct mode to generate a prediction image.

The motion vector information is not stored in the compressed image in the direct mode. Specifically, on the decoding side, with motion vector information around the object block, or a reference picture, the motion vector information of the object block is extracted from the motion vector information of a co-located block that is a block having the same coordinates as the object block. Accordingly, there is no need to transmit the motion vector information to the decoding side.

This direct mode includes two types of a spatial direct mode (Spatial Direct Mode) and a temporal direct mode (Temporal Direct Mode). The spatial direct mode is a mode for taking advantage of correlation of motion information principally in the spatial direction (horizontal and vertical two-dimensional space within a picture), and generally has an advantage in the event of an image including similar motions of which the motion speeds vary. On the other hand, the temporal direct mode is a mode for taking advantage of correlation of motion information principally in the temporal direction, and generally has an advantage in the event of an image including different motions of which the motion speeds are constant.

Specifically, even within the same slice, whether the optimal direct mode is the spatial direct mode or temporal direct mode differs for each object block. Therefore, the motion vector information according to the spatial direct mode and the motion vector information according to the spatial and temporal direct mode are calculated by the motion prediction/compensation unit 75, and the optimal direct mode is selected as to the object block to be encoded by the direct mode selecting unit 76 using the motion vector information thereof.

The motion prediction/compensation unit 75 calculates the motion vector information according to the spatial direct mode and the temporal direct mode, and uses the calculated motion vector information to perform compensation processing and generate a prediction image. At this time, the motion prediction/compensation unit 75 outputs the calculated motion vector information according to the spatial direct mode, and the calculated motion vector information according to the temporal direct mode to the direct mode selecting unit 76.

Also, the motion prediction/compensation unit 75 calculates a cost function value as to all of the inter prediction modes serving as candidates, and the direct mode selected by the direct mode selecting unit 76. The motion prediction/compensation unit 75 determines, of the calculated cost function values, a prediction mode that provides the minimum value, to be the optimal inter prediction mode.

The motion prediction/compensation unit 75 supplies the prediction image generated in the optimal inter prediction mode, and the cost function value thereof to the prediction image selecting unit 77. In the event that the prediction image generated in the optimal inter prediction mode has been selected by the prediction image selecting unit 77, the motion prediction/compensation unit 75 outputs information indicating the optimal inter prediction mode (inter prediction mode information or direct mode information) to the lossless encoding unit 66.

Note that, according to need, the motion vector information, flag information, reference frame information, and so forth are output to the lossless encoding unit 66. The lossless encoding unit 66 also subjects the information from the motion prediction/compensation unit 75 to lossless encoding processing such as variable length coding or arithmetic coding, and inserts into the header portion of the compressed image.

The direct mode selecting unit 76 uses the motion vector information according to the spatial direct mode and temporal direct mode from the motion prediction/compensation unit 75 to calculate the corresponding residual energy (prediction error). At this time, along with the motion vector information, a peripheral pixel adjacent to the object block to be encoded in a predetermined positional relation and included in a decoded image is used to calculate the residual energy.

The direct mode selecting unit 76 compares the two types of residual energy according to the spatial direct mode and temporal direct mode, selects one having smaller residual energy as the optimal direct mode, and outputs information indicating the type of the selected direct mode to the motion prediction/compensation unit 75.

The prediction image selecting unit 77 determines the optimal prediction mode from the optimal intra prediction mode and the optimal inter prediction mode based on the cost function values output from the intra prediction unit 74 or motion prediction/compensation unit 75. The prediction image selecting unit 77 then selects the prediction image in the determined optimal prediction mode, and supplies to the computing units 63 and 70. At this time, the prediction image selecting unit 77 supplies the selection information of the prediction image to the intra prediction unit 74 or motion prediction/compensation unit 75.

The rate control unit 78 controls the rate of the quantization operation of the quantization unit 65 based on a compressed image accumulated in the accumulating buffer 67 so as not to cause overflow or underflow.

Description of H.264/AVC System

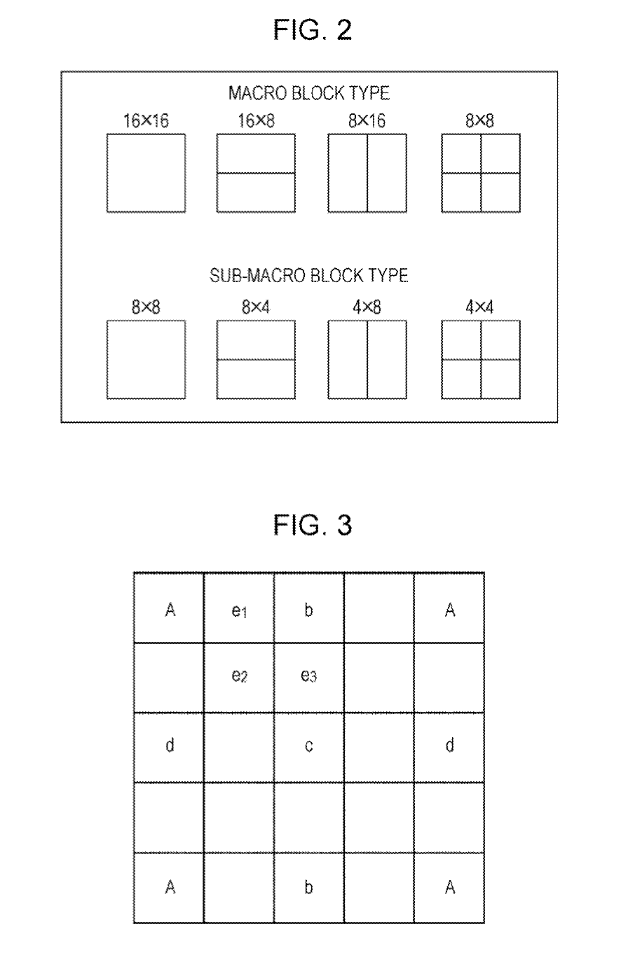

FIG. 2 is a diagram illustrating an example of the block size of motion prediction and compensation according to the H.264/AVC system. With the H.264/AVC system, motion prediction and compensation is performed with the block size taken as variable.

Macro blocks made up of 16×16 pixels divided into 16×16-pixel, 16×8-pixel, 8×16-pixel, and 8×8-pixel partitions are shown from the left in order on the upper tier in FIG. 2. Also, 8×8-pixel partitions divided into 8×8-pixel, 8×4-pixel, 4×8-pixel, and 4×4-pixel sub partitions are shown from the left in order on the lower tier in FIG. 2.

Specifically, with the H.264/AVC system, one macro block may be divided into one of 16×16-pixel, 16×8-pixel, 8×16-pixel, and 8×8-pixel partitions with each partition having independent motion vector information. Also, an 8×8-pixel partition may be divided into one of 8×8-pixel, 8×4-pixel, 4×8-pixel, and 4×4-pixel sub partitions with each sub partition having independent motion vector information.

FIG. 3 is a diagram for describing prediction and compensation processing with ¼ pixel precision according to the H.264/AVC system. With the H.264/AVC system, prediction and compensation processing with ¼ pixel precision using 6-tap FIR (Finite Impulse Response Filter) filter is performed.

With the example in FIG. 3, positions A indicate the positions of integer precision pixels, and positions b, c, and d indicate positions with ½ pixel precision, and positions e1, e2, and e3 indicate positions with ¼ pixel precision. First, hereafter, Clip( ) is defined like the following Expression (1).

$$\begin{matrix}[ Mathematical Expression 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

Note that, in the event that the input image has 8-bit precision, the value of max_pix becomes 255.

The pixel values in the positions band d are generated like the following Expression (2) using a 6-tap FIR filter.

[Mathematical Expression 2]

F=A₋₂−5·A₋₁+20·A₀+20·A₁−5·A₂+A₃

b,d=Clip1((F+16)>>5) (2)

The pixel value in the position c is generated like the following Expression (3) by applying a 6-tap FIR filter in the horizontal direction and the vertical direction.

[Mathematical Expression 3]

F=b₋₂−5·b₋₁+20·b₀+20·b₁−5·b₂+b₃

or

F=d₋₂−5·d₋₁+20·d₀+20·d₁−5·d₂+d₃

c=Clip1((F+512)>>10 (3)

Note that Clip processing is lastly executed only once after both of sum-of-products processing in the horizontal direction and the vertical direction are performed.

Positions e1 through e3 are generated by linear interpolation as shown in the following Expression (4).

[Mathematical Expression 4]

e₁=(A+b+1)>>1

e₂=(b+d+1)>>1

e₃=(b+c+1)>>1 (4)

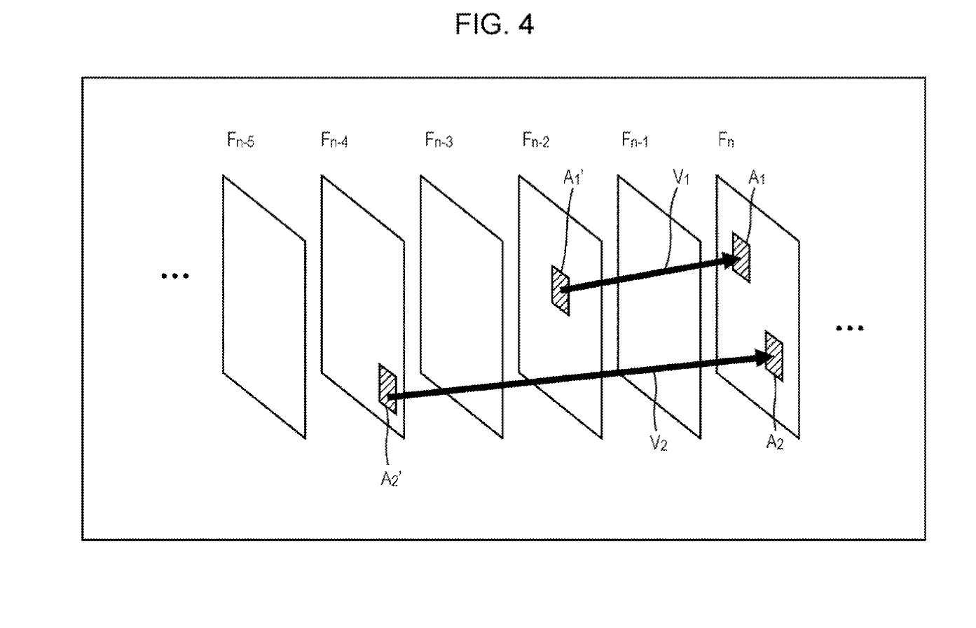

FIG. 4 is a diagram for describing the prediction and compensation processing of multi-reference frames according to the H.264/AVC system. With the H2264/AVC system, the motion prediction and compensation method of multi-reference frames (Multi-Reference Frame) has been determined.

With the example in FIG. 4, the object frame Fn to be encoded from now on, and encoded frames Fn-5 through Fn-1 are shown. The frame Fn-1 is, on the temporal axis, a frame one frame ahead of the object frame Fn, the frame Fn-2 is a frame two frames ahead of the object frame Fn, and the frame Fn-3 is a frame three frames ahead of the object frame Fn. Similarly, the frame Fn-4 is a frame four frames ahead of the object frame Fn, and the frame Fn-5 is a frame five frames ahead of the object frame Fn. In general, the closer to the object frame Fn a frame is on the temporal axis, the smaller a reference picture number (ref_id) to be added is. Specifically, the frame Fn-1 has the smallest reference picture number, and hereafter, the reference picture numbers are small in the order of Fn-2, . . . , Fn-5.

With the object frame Fn, a block A1 and a block A2 are shown, a motion vector V1 is searched with assuming that the block A1 is correlated with a block A1′ of the frame Fn-2 that is two frames ahead of the object frame Fn. Similarly, a motion vector V2 is searched with assuming that the block A2 is correlated with a block A1′ of the frame Fn-4 that is four frames ahead of the object frame Fn.

As described above, with the H.264/AVC system, different reference frames may be referenced in one frame (picture) with multi-reference frames stored in memory. Specifically, for example, such that the block A1 references the frame Fn-2, and the block A2 reference the frame Fn-4, independent reference frame information (reference picture number (ref_id)) may be provided for each block in one picture.

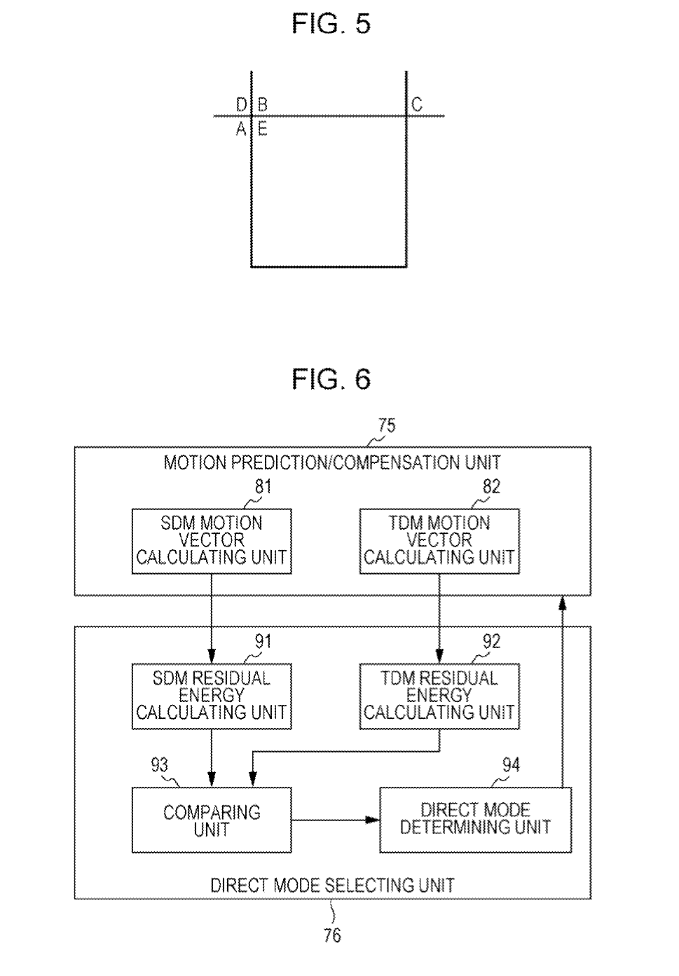

With the H.264/AVC system, by the motion prediction and compensation processing described above with reference to FIGS. 2 through 4 being performed, vast amounts of motion vector information are generated, and if these are encoded without change, deterioration in encoding efficiency is caused. In response to this, with the H.264/AVC system, according to a method shown in FIG. 5, reduction in motion vector coding information has been realized.

FIG. 5 is a diagram for describing a motion vector information generating method according to the H.264/AVC system.

With the example in FIG. 5, an object block E to be encoded from now on (e.g., 16×16 pixels), and blocks A through D, which have already been encoded, adjacent to the object block E are shown.

Specifically, the block D is adjacent to the upper left of the object block E, the block B is adjacent to above the object block E, the block C is adjacent to the upper right of the object block E, and the block A is adjacent to the left of the object block E. Note that the reason why the blocks A through D are not sectioned is because each of the blocks represents a block having one structure of 16×16 pixels through 4×4 pixels described above with reference to FIG. 2.

For example, let us say that motion vector information as to X (=A, B, C, D, E) is represented with mv_{X}. First, prediction motion vector information pmv_{E} as to the object block E is generated like the following Expression (5) by median prediction using motion vector information regarding the blocks A, B, and C.

pmv_{E}=med(mv_{A},mv_{B},mv_{C}) (5)

The motion vector information regarding the block C may not, be used (may be unavailable) due to a reason such as the edge of an image frame, before encoding, or the like. In this case, the motion vector information regarding the block D is used instead of the motion vector information regarding the block C.

Data mvd_{E} to be, added to the header portion of the compressed image, serving as the motion vector information as to the object block E, is generated like the following Expression (6) using pmv_{E}.

mvd_{E}=mv_{E}−pmv_{E} (6)

Note that, in reality, processing is independently performed as to the components in the horizontal direction and vertical direction of the motion vector information.

In this way, prediction motion vector information is generated, difference between the prediction motion vector information generated based on correlation with an adjacent block, and the motion vector information is added to the header portion of the compressed image, whereby the motion vector information can be reduced.

Configuration Example of Direct Mode Selecting Unit

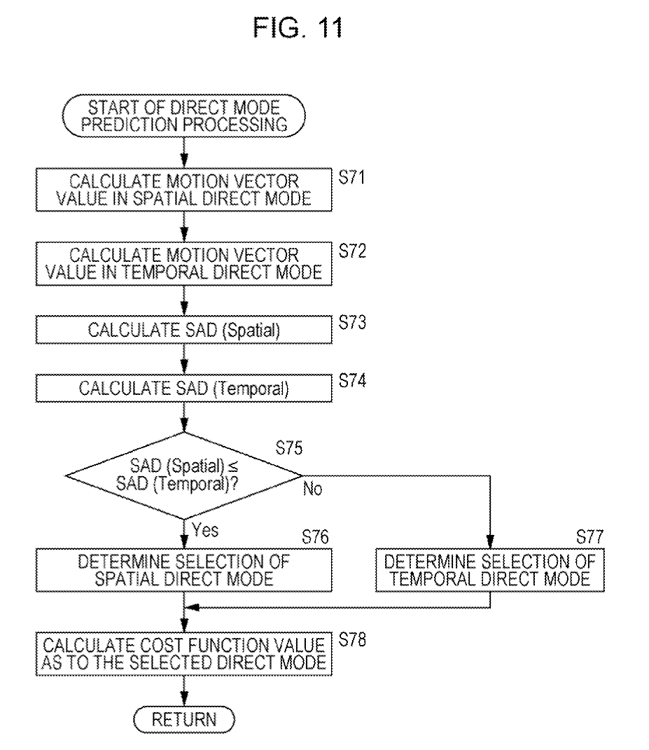

FIG. 6 is a block diagram illustrating a detailed configuration example of the direct mode selecting unit. Note that, with the example in FIG. 6, of the motion prediction/compensation unit 75, the units which perform part of later-described direct mode prediction processing in FIG. 11 are also illustrated.

In the case of the example in FIG. 6, the motion prediction/compensation unit 73 is configured so as to include a Spatial Direct Mode (hereafter, referred to as SDM) motion vector calculating unit 81 and a Temporal Direct Mode (hereafter, referred to as TDM) motion vector calculating unit 82.

The direct mode selecting unit 76 is configured of an SDM residual energy calculating unit 91, a TDM residual energy calculating unit 92, a comparing unit 93, and a direct mode determining unit 94.

The SDM motion vector calculating unit 81 performs motion prediction and compensation processing based on the spatial direct mode regarding B pictures to generate a prediction image. Note that, in the event of a B picture, motion prediction and compensation processing is performed as to both reference frames of List0 (L0) and List1 (L1).

At this time, with the SDM motion vector calculating unit 81, based on the spatial direct mode, a motion vector directmv_{L0} (Spatial) is calculated by motion prediction between the object frame and the L0 reference frame. Similarly, a motion vector directmv_{L1} (Spatial) is calculated by motion prediction between the object frame and the L1 reference frame. These calculated motion vector directmv_{L0} (Spatial) and motion vector directmv_{L1} (Spatial) are output to the SDM residual energy calculating unit 91.

The TDM motion vector calculating unit 82 performs motion prediction and compensation processing based on the temporal direct mode regarding B pictures to generate a prediction image.

At this time, with the TDM motion vector calculating unit 82, based on the temporal direct mode, a motion vector directmv_{L0} (Temporal) is calculated by motion prediction between the object frame and the L0 reference frame. Similarly, a motion vector directmv_{L1} (Temporal) is calculated by motion prediction between the object frame and the L1 reference frame. These calculated motion vector directmv_{L0} (Temporal) and motion vector directmv_{L1} (Temporal) are output to the TDM residual energy calculating unit 92.

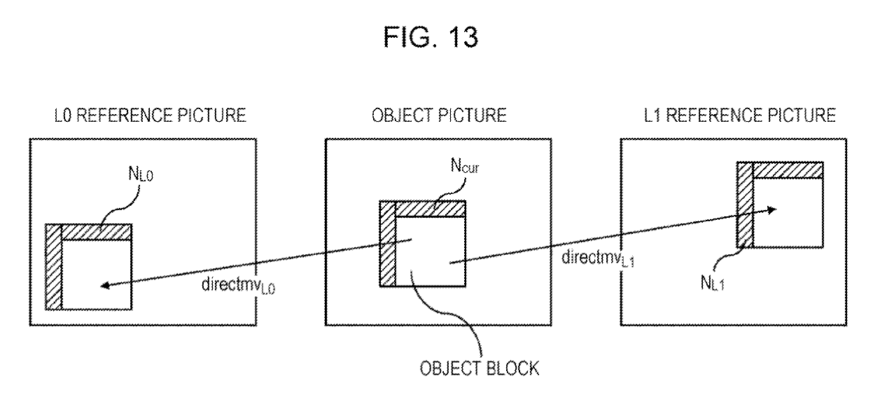

The SDM residual energy calculating unit 91 obtains pixel groups N_{L0} and N_{L1} on each reference frame corresponding to a peripheral pixel group N_{CUR} of the object block to be encoded, specified by the motion vector directmv_{L0} (Spatial) and motion vector directmv_{L1} (Spatial). This peripheral pixel group N_{CUR} is an already encoded pixel group around the object block, for example. Note that the details of the peripheral pixel group N_{CUR} will be described later with reference to FIG. 13.

The SDM residual energy calculating unit 91 uses the pixel values of the peripheral pixel group N_{CUR} of the object block, and the pixel values of the obtained pixel groups N_{L0} and N_{L1} on each reference frame to calculate the corresponding residual energies using SAD (Sum of Absolute Difference).

Further, the SDM residual energy calculating unit 91 uses residual energy SAD(N_{L0}; Spatial) as to the pixel group N_{L0} on the L0 reference frame, and residual energy SAD(N_{L1}; Spatial) as to the pixel group N_{L1} on the L1 reference frame to calculate residual energy SAD(Spatial). The residual energy SAD(Spatial) is calculated by the following Expression (7). The calculated residual energy SAD(Spatial) is output to the comparing unit 93.

SAD(Spatial)=SAD(N_{L0};Spatial)+SAD(N_{L1};Spatial) (7)

The TDM residual energy calculating unit 92 obtains pixel groups N_{L0} and N_{L1} on each reference frame corresponding to a peripheral pixel group N_{CUR} of the object block to be encoded, specified by the motion vector directmv_{L0}(Temporal) and motion vector directmv_{L1} (Temporal). The TDM residual energy calculating unit 92 uses the pixel values of the peripheral pixel group N_{CUR} of the object block, and the obtained pixel groups N_{L0} and N_{L1} on each reference frame to calculate the corresponding residual energies using SAD.

Further, the TDM residual energy calculating unit 92 uses residual energy SAD(N_{L0}; Temporal) as to the pixel group N_{L0} on the L0 reference frame, and residual energy SAD(N_{L1}; Temporal) as to the pixel group N_{L1} on the L1 reference frame to calculate residual energy SAD(Temporal). The residual energy SAD(Temporal) is calculated by the following Expression (8). The calculated residual energy SAD(Temporal) is output to the comparing unit 93.

SAD(Temporal)=SAD(N_{L0};Temporal)+SAD(N_{L1};Temporal) (8)

The comparing unit 93 performs comparison between the residual energy SAD(Spatial) based on the spatial direct mode, and the residual energy SAD(Temporal) based on the temporal direct mode, and outputs the result thereof to the direct mode determining unit 94.

The direct mode determining unit 94 determines based on the following Expression (9) whether the object block is encoded in the spatial direct mode or spatial direct mode. That is to say, selection of the optimal direct mode is determined as to the object block.

SAD(Spatial)≦SAD(Temporal) (9)

Specifically, in the event that Expression (9) holds, and the residual energy SAD(Spatial) is equal to or smaller than the residual energy SAD(Temporal), the direct mode determining unit 94 determines selection of the spatial direct mode to be the optimal direct mode of the object block. On the other hand, in the event that Expression (9) does not hold, and the residual energy SAD(Spatial) is greater than the residual energy SAD(Temporal), the direct mode determining unit 94 determines selection of the temporal direct mode to be the optimal direct mode of the object block. Information indicating the type of the selected direct mode is output to the motion prediction/compensation unit 75.

Note that description has been made so far regarding the case for obtaining residual energy using SAD, but SSD (Sum of Squared Difference) may be employed instead of SAD, for example. By employing SAD, selection of the optimal direct mode can be determined with less calculation amount than the case of SSD. On the other hand, by employing SSD, selection of the optimal direct mode can be determined with higher precision than the case of SAD.

Also, with the above-mentioned SAD calculation processing, a luminance signal alone may be employed, or in addition to a luminance signal, a color difference signal may also be employed. Further, alternatively, an arrangement may be made wherein SAD calculation processing is performed for each of the Y/Cb/Cr signal components, and comparison of SAD is performed for each of the Y/Cb/Cr signal components.

By performing SAD calculation processing using a luminance signal alone, determination of the direct mode can be realized with less calculation amount, but by adding a color difference signal to this, selection of the optimal direct mode can be determined with higher precision. Also, there may be case where the optimal direct mode differs as to each of Y/Cb/Cr, and accordingly, the above-mentioned calculation processing is performed separately for each of the components, and the optimal direct mode is determined for each of the components, whereby determination can be made with further high precision.

Description of Encoding Processing of Image Encoding Device

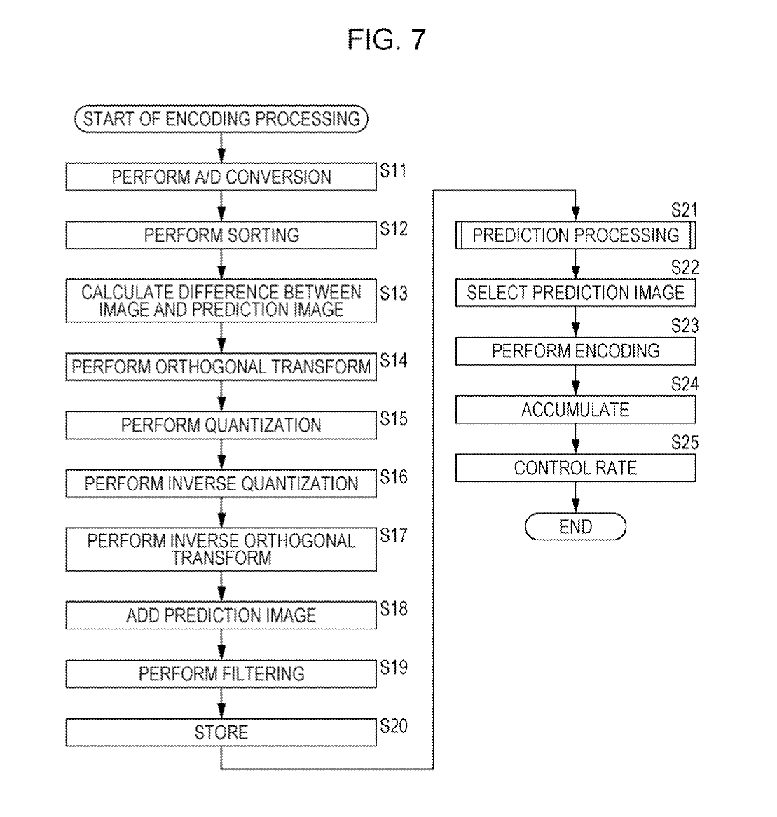

Next, the encoding processing of the image encoding device 51 in FIG. 1 will be described with reference to the flowchart in FIG. 7.

In step S11, the A/D conversion unit 61 converts an input image from analog to digital. In step S12, the screen sorting buffer 62 stores the image supplied from the A/D conversion unit 61, and performs sorting from the sequence for displaying the pictures to the sequence for encoding.

In step S13, the computing unit 63 computes difference between an image sorted in step S12 and the prediction image. The prediction image is supplied to the computing unit 63 from the motion prediction/compensation unit 75 in the event of performing inter prediction, and from the intra prediction unit 74 in the event of performing intra prediction, via the prediction image selecting unit 77.

The difference data is smaller in the data amount as compared to the original image data. Accordingly, the data amount can be compressed as compared to the case of encoding the original image without change.

In step S14, the orthogonal transform unit 64 subjects the difference information supplied from the computing unit 63 to orthogonal transform. Specifically, orthogonal transform, such as discrete cosine transform, Karhunen-Loéve transform, or the like, is performed, and a transform coefficient is output. In step S15, the quantization unit 65 quantizes the transform coefficient. At the time of this quantization, a rate is controlled such that later-described processing in step S25 will be described.

The difference information thus quantized is locally decoded as follows. Specifically, in step S16, the inverse quantization unit 68 subjects the transform coefficient quantized by the quantization unit 65 to inverse quantization using a property corresponding to the property of the quantization unit 65. In step S17, the inverse orthogonal transform unit 69 subjects the transform coefficient subjected to inverse quantization by the inverse quantization unit 68 to inverse orthogonal transform using a property corresponding to the property of the orthogonal transform unit 64.

In step S18, the computing unit 70 adds the prediction image input via the prediction image selecting unit 77 to the locally decoded difference information, and generates a locally decoded image (the image corresponding to the input to the computing unit 63). In step S19, the deblocking filter 71 subjects the image output from the computing unit 70 to filtering. Thus, block distortion is removed. In step S20, the frame memory 72 stores the image subjected to filtering. Note that an image not subjected to filtering processing by the deblocking filter 71 is also supplied from the computing unit 70 to the frame memory 72 for storing.

In step S21, the intra prediction unit 74 and motion prediction/compensation unit 75 each perform image prediction processing. Specifically, in step S21, the intra prediction unit 74 performs intra prediction processing in the intra prediction mode. The motion prediction/compensation unit 75 performs motion prediction and compensation processing in the inter prediction mode, and further performs motion prediction and compensation processing in the spatial and temporal direct modes regarding B pictures. At this time, the direct mode selecting unit 76 uses the motion vector information in the spatial direct mode and temporal direct mode calculated by the motion prediction/compensation unit 75 to select the optimal direct mode.

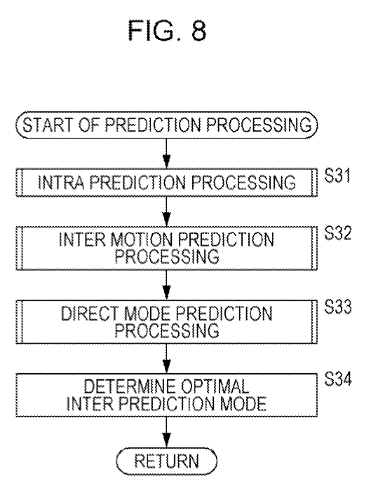

The details of the prediction processing in step S21 will be described later with reference to FIG. 8, but according to this processing, the prediction processes in all of the prediction modes serving as candidates are performed, and the cost function values in all of the prediction modes serving as candidates are calculated. The optimal intra prediction mode is selected based on the calculated cost function values, and the prediction image generated by the intra prediction in the optimal intra prediction mode, and the cost function value thereof are supplied to the prediction image selecting unit 77.

Also, with regard to P pictures, the optimal inter prediction mode is determined out of the inter prediction modes based on the calculated cost function values, the prediction image generated in the optimal inter prediction mode and the cost function value thereof are supplied to the prediction image selecting unit 77.

On the other hand, with regard to B pictures, the optimal inter prediction mode is determined out of the inter prediction modes, and the direct mode selected by the direct mode selecting unit 76 based on the calculated cost function values. The prediction image generated in the optimal inter prediction mode and the cost function value thereof are then supplied to the prediction image selecting unit 77.

In step S22, the prediction image selecting unit 77 determines one of the optimal intra prediction mode and the optimal inter prediction mode to be the optimal prediction mode based on the cost function values output from the intra prediction unit 74 and the motion prediction/compensation unit 75. The prediction image selecting unit 77 then selects the prediction image in the determined optimal prediction mode, and supplies to the computing units 63 and 70. This prediction image is, as described above, used for calculations in steps S13 and S18.

Note that the selection information of this prediction image is supplied to the intra prediction unit 74 or motion prediction/compensation unit 75. In the event that the prediction image in the optimal intra prediction mode has been selected, the intra prediction unit 74 supplies information indicating the optimal intra prediction mode (i.e., intra prediction mode information) to the lossless encoding unit 66.

In the event that the prediction image in the optimal inter prediction mode has been selected, the motion prediction/compensation unit 75 outputs information indicating the optimal inter prediction mode (including a direct mode), according to need, information according to the optimal inter prediction mode to the lossless encoding unit 66. Examples of the information according to the optimal inter prediction mode include motion vector information, flag information, and reference frame information. Further, specifically, in the event that the prediction image according to the inter prediction mode has been selected as the optimal inter prediction mode, the motion prediction/compensation unit 75 outputs the inter prediction mode information, motion vector information, and reference frame information to the lossless encoding unit 66.

On the other hand, in the event that the prediction image according to a direct mode has been selected as the optimal inter prediction mode, the motion prediction/compensation unit 75 outputs only information indicating the direct mode for each slice to the lossless encoding unit 66. That is to say, in the event of encoding according to a direct mode, the motion vector information and so forth do not need to be transmitted to the decoding side, and accordingly not output to the lossless encoding unit 66. Further, information indicating the type of a direct mode for each block is also not transmitted to the decoding side. Accordingly, the motion vector information in the compressed image can be reduced.

In step S23, the lossless encoding unit 66 encodes the quantized transform coefficient output from the quantization unit 65. Specifically, the difference image is subjected to lossless encoding such as variable length coding, arithmetic coding, or the like, and compressed. At this time, the intra prediction mode information from the intra prediction unit 74, or the information according to the optimal inter prediction mode from the motion prediction/compensation unit 75, and so forth input to the lossless encoding unit 66 in step S22 described above are also encoded, and added to the header information.

In step S24, the accumulating buffer 67 accumulates the difference image as the compressed image. The compressed image accumulated in the accumulating buffer 67 is read out as appropriate, and transmitted to the decoding side via the transmission path.

In step S25, the rate control unit 78 controls the rate of the quantization operation of the quantization unit 65 based on the compressed image accumulated in the accumulating buffer 67 so as not to cause overflow or underflow.

Description of Prediction Processing of Image Encoding Device

Next, the prediction processing in step S21 in FIG. 7 will be described with reference to the flowchart in FIG. 8.

In the event that the image to be processed, supplied from the screen sorting buffer 62, is an image in a block to be subjected to intra processing, the decoded image to be referenced is read out from the frame memory 72, and supplied to the intra prediction unit 74 via the switch 73. In step S31, based on these images, the intra prediction unit 74 performs intra prediction as to the pixels in the block to be processed using all of the intra prediction modes serving as candidates. Note that pixels not subjected to deblocking filtering by the deblocking filter 71 are used as the decoded pixels to be referenced.

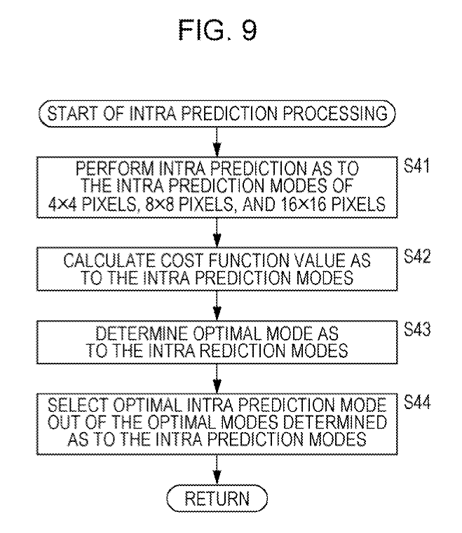

The details of the intra prediction processing in step S31 will be described later with reference to FIG. 9, but according to this processing, intra prediction is performed using all of the intra prediction modes serving as candidates, and a cost function value is calculated as to all of the intra prediction modes serving as candidates. The optimal intra prediction mode is then selected based on the calculated cost function values, and the prediction image generated by the intra prediction in the optimal intra prediction mode, and the cost function value thereof are supplied to the prediction image selecting unit 77.

In the event that the image to be processed supplied from the screen sorting buffer 62 is an image to be subjected to inter processing, the image to be referenced is read out from the frame memory 72, and supplied to the motion prediction/compensation unit 75 via the switch 73. In step S32, based on these images, the motion prediction/compensation unit 75 performs inter motion prediction processing. That is to say, the motion prediction/compensation unit 75 references the image supplied from the frame memory 72 to perform the motion prediction processing in all of the inter prediction modes serving as candidates.

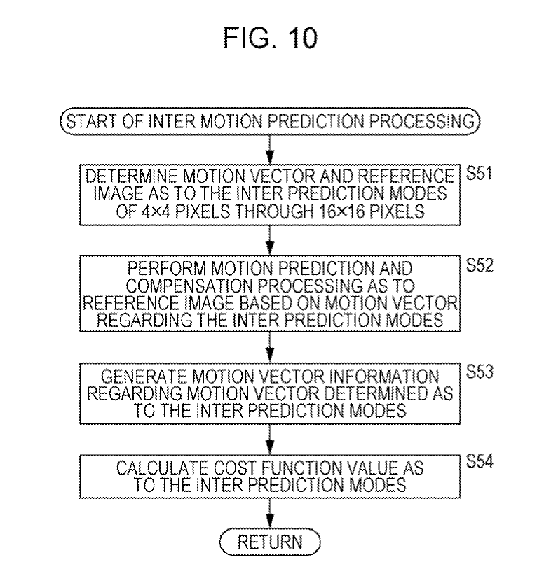

The details of the inter motion prediction processing in step S32 will be described later with reference to FIG. 10, but according to this processing, the motion prediction processing in all of the inter prediction modes serving as candidates is performed, and a cost function value as to all of the inter prediction modes serving as candidates is calculated.

Further, in the event that the image to be processed is a B picture, the motion prediction/compensation unit 75 and direct mode selecting unit 76 perform direct mode prediction processing in step S33.

The details of the direct mode prediction processing in step S33 will be described later with reference to FIG. 11. According to this processing, motion prediction and compensation processing based on the spatial and temporal direct modes is performed. The motion vector values according to the spatial and temporal direct modes calculated at this time are used to select the optimal direct mode from which of the spatial and temporal direct modes. Further, a cost function value is calculated as to the selected direct mode.

In step S34, the motion prediction/compensation unit 75 compares the cost function values as to the inter prediction modes calculated in step S32, and the cost function value as to the direct mode calculated in step S33. The motion prediction/compensation unit 75, determines the prediction mode that provides the minimum value, to be the optimal inter prediction mode, and supplies the prediction image generated in the optimal inter prediction mode, and the cost function value thereof to the prediction image selecting unit 77.

Note that, in the event that the image to be processed is a P picture, the processing in step S33 is skipped, and in step S34, the optimal inter prediction mode is determined output of the inter prediction modes where a prediction image is generated in step S32.

Description of Intra Prediction Processing of Image Encoding Device

Next, the intra prediction processing in step S31 in FIG. 8 will be described with reference to the flowchart in FIG. 9. Note that, with the example in FIG. 9, description will be made regarding a case of a luminance signal as an example.

In step S41, the intra prediction unit 74 performs intra prediction as to the intra prediction modes of 4×4 pixels, 8×8 pixels, and 16×16 pixels.

With regard to intra prediction modes for a luminance signal, there are provided nine kinds of prediction modes in block units of 4×4 pixels and 8×8 pixels, and four kinds of prediction modes in macro block units of 16×16 pixels, and with regard to intra prediction modes for a color difference signal, there are provided four kinds of prediction modes in block units of 8×8 pixels. The intra prediction modes for color difference signals may be set independently from the intra prediction modes for luminance signals. With regard to the intra prediction modes of 4×4 pixels and 8×8 pixels of a luminance signal, one intra prediction mode is defined for each luminance signal block of 4×4 pixels and 8×8 pixels. With regard to the intra prediction mode of 16×16 pixels of a luminance signal, and the intra prediction mode of a color difference signal, one prediction mode is defined as to one macro block.

Specifically, the intra prediction unit 74 performs intra prediction as to the pixels in the block to be processed with reference to the decoded image read out from the frame memory 72 and supplied via the switch 73. This intra prediction processing is performed in the intra prediction modes, and accordingly, prediction images in the intra prediction modes are generated. Note that pixels not subjected to deblocking filtering by the deblocking filter 71 are used as the decoded pixels to be referenced.

In step S42, the intra prediction unit 74 calculates a cost function value as to the intra prediction modes of 4×4 pixels, 8×8 pixels, and 16×16 pixels. Here, calculation of a cost function value is performed based on one of the techniques of a High Complexity mode or Low Complexity mode. These modes are determined in JM (Joint Model) that is reference software in the H.264/AVC system.

Specifically, in the High Complexity mode, tentatively, up to encoding processing is performed as to all of the prediction modes serving as candidates as the processing in step S41. A cost function value represented with the following Expression (10) is calculated as to the prediction modes, and a prediction mode that provides the minimum value thereof is selected as the optimal prediction mode.

Cost(Mode)=D+λ·R (10)

D denotes difference (distortion) between the raw image and a decoded image, R denotes a generated code amount including an orthogonal transform coefficient, and λ denotes a LaGrange multiplier to be provided as a function of a quantization parameter QP.

On the other hand, in the Low Complexity mode, a prediction image is generated, and up to header bits of motion vector information, prediction mode information, flag information, and so forth are calculated as to all of the prediction modes serving as candidates as the processing in step S41. A cost function value represented with the following Expression (11) is calculated as to the prediction modes, and a prediction mode that provides the minimum value thereof is selected as the optimal prediction mode.

Cost(Mode)=D+QPtoQuant(QP)·Header_Bit (11)

D denotes difference (distortion) between the raw image and a decoded image, Header_Bit denotes header bits as to a prediction mode, and QPtoQuant is a function to be provided as a function of the quantization parameter QP.

In the Low Complexity mode, a prediction image is only generated as to all of the prediction modes, and there is no need to perform encoding processing and decoding processing, and accordingly, a calculation amount can be reduced.

In step S43, the intra prediction unit 74 determines the optimal mode as to the intra prediction modes of 4×4 pixels, 8×8 pixels, and 16×16 pixels. Specifically, as described above, in the event of the intra 4×4 prediction mode and intra 8×8 prediction mode, the number of prediction mode types is nine, and in the event the intra 16×16 prediction mode, the number of prediction mode types is four. Accordingly, the intra prediction unit 74 determines, based on the cost function values calculated in step S42, the optimal intra 4×4 prediction mode, optimal intra 8×8 prediction mode, and optimal intra 16×16 prediction mode out thereof.

In step S44, the intra prediction unit 74 selects the optimal intra prediction mode out of the optimal modes determined as to the intra prediction modes of 4×4 pixels, 8×8 pixels, and 16×16 pixels based on the cost function values calculated in step S42. Specifically, the intra prediction unit 74 selects a mode of which the cost function value is the minimum value out of the optimal modes determined as to 4×4 pixels, 8×8 pixels, and 16×16 pixels, as the optimal intra prediction mode. The intra prediction unit 74 then supplies the prediction image generated in the optimal intra prediction mode, and the cost function value thereof to the prediction image selecting unit 77.

Description of Inter Motion Prediction Processing of Image Encoding Device

Next, the inter motion prediction processing in step S32 in FIG. 8 will be described with reference to the flowchart in FIG. 10.

In step S51, the motion prediction/compensation unit 75 determines a motion vector and a reference image as to each of the eight kinds of the inter prediction modes made up of 16×16 pixels through 4×4 pixels described above with reference to FIG. 2. That is to say, a motion vector and a reference image are determined as to the block to be processed in each of the inter prediction modes.

In step S52, the motion prediction/compensation unit 75 subjects the reference image to motion prediction and compensation processing based on the motion vector determined in step S51 regarding each of the eight kinds of the inter prediction modes made up of 16×16 pixels through 4×4 pixels. According to this motion prediction and compensation processing, a prediction image in each of the inter prediction modes is generated.

In step S53, the motion prediction/compensation unit 75 generates motion vector information to be added to the compressed image regarding the motion vectors determined as to each of the eight kinds of the inter prediction modes made up of 16×16 pixels through 4×4 pixels. At this tithe, the motion vector generating method described above with reference to FIG. 5 is employed to generate the motion vector information.

The generated motion vector information is also employed at the time calculation of cost function values in the next step S54, and in the event that the corresponding prediction image has ultimately been selected by the prediction image selecting unit 77, this prediction image is output to the lossless encoding unit 66 along with the prediction mode information and reference frame information.

In step S54, the motion prediction/compensation unit 75 calculates the cost function value shown in the above-mentioned Expression (10) or Expression (11) as to each of the eight kinds of the inter prediction modes made up of 16×16 pixels through 4×4 pixels. The cost function value calculated here is employed at the time of determining the optimal inter prediction mode in the above-mentioned step S34 in FIG. 8.

Description of Direct Mode Prediction Processing of Image Encoding Device

Next, the direct mode prediction processing in step S33 in FIG. 8 will be described with reference to the flowchart in FIG. 11. Note that this processing is performed only in the case of the object image being a B picture.

In step S71, the SDM motion vector calculating unit 81 calculates a motion vector value in the spatial direct mode.

Specifically, the SDM motion vector calculating unit 81 performs motion prediction and compensation processing based on the spatial direct mode to generate a prediction image. At this time, with the SDM motion vector calculating unit 81, based on the spatial direct mode, a motion vector directmv_{L0} (Spatial) is calculated with motion prediction between the object frame and an L0 reference frame. Similarly, a motion vector directmv_{L1} (Spatial) is calculated with motion prediction between the object frame and an L1 reference frame.

The spatial direct mode according to the H.264/AVC system with be described again with reference to FIG. 5. With the example in FIG. 5, as described above, an object block E (e.g., 16×16 pixels) to be encoded from now on, and already encoded blocks A through D adjacent to the object block E are shown. Motion vector information as to X (=A, B, c, D, E) is represented with mvₓ, for example.

Prediction motion vector information pmv_{E} as to the object block E is generated by medial prediction like the above-mentioned Expression (5) using the motion vector information relating to the blocks A, B, and C. Motion vector information mv_{E} as to the object block E in the spatial direct mode is represented like the following Expression (12).

mv_{E}=pmv_{E} (12)

Specifically, in the spatial direct mode, the prediction motion vector information generated by median prediction is taken as the motion vector information of the object block. That is to say, the motion vector information of the object block is generated with the motion vector information of an encoded block. Accordingly, the motion vector according to the spatial direct mode can be generated even on the decoding side, and accordingly, the motion vector information does not need to be transmitted to the decoding side.

The calculated motion vector directmv_{L0} (Spatial) and motion vector directmv_{L1} (Spatial) are output to the SDM residual energy calculating unit 91.

In step S72, the TDM motion vector calculating unit 82 calculates the motion vector value in the temporal direct mode.

Specifically, the TDM motion vector calculating unit 82 performs motion prediction and compensation processing regarding B pictures based on the temporal direct mode to generate a prediction image.

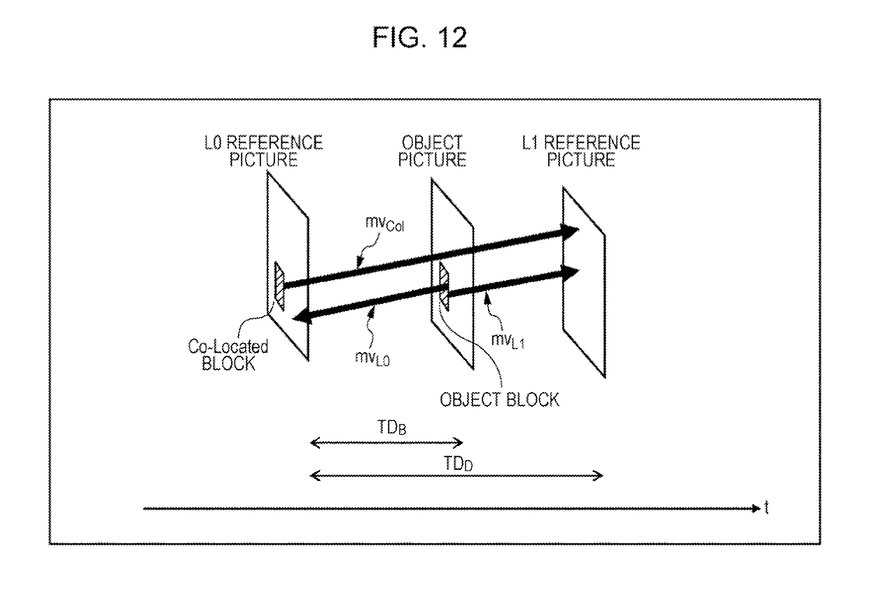

At this time, with the TDM motion vector calculating unit 82, based on the temporal direct mode, a motion vector directmv_{L0} (Temporal) is calculated with motion prediction between the object frame and an L0 reference frame. Similarly, a motion vector directmv_{L1} (Temporal) is calculated with motion prediction between the object frame and an L1 reference frame. Note that the motion vector calculation processing based on the temporal direct mode will be described later with reference to FIG. 12.

The calculated motion vector directmv_{L0} (Temporal) and motion vector directmv_{L1} (Temporal) are output to the TDM residual energy calculating unit 92.

Note that, with the H.264/AVC system, both of these direct modes (spatial direct mode and temporal direct mode) can be defined in increments of 16×16-pixel macro blocks or 8×8-pixel blocks. Accordingly, with the SDM motion vector calculating unit 81 and TDM motion vector calculating unit 82, processing in increments of 16×16-pixel macro blocks or 8×8-pixel blocks is performed.

In step S73, the SDM residual energy calculating unit 91 uses the motion vector according to the spatial direct mode to calculate residual energy SAD(Spatial), and outputs the calculated residual energy SAD(Spatial) to the comparing unit 93.

Specifically, the SDM residual energy calculating unit 91 obtains pixel groups N_{L0} and N_{L1} on each reference frame corresponding to a peripheral pixel group N_{CUR} of the object block to be encoded, specified by the motion vectors directmv_{L0} (Spatial) and directmv_{L1} (Spatial). The SDM residual energy calculating unit 91 uses the pixel values of the peripheral pixel group N_{CUR} of the object block, and the pixel values of the obtained pixel groups N_{L0} and N_{L1} on each reference frame to calculate the corresponding residual energies using SAD.

Further, the SDM residual energy calculating unit 91 uses residual energy SAD(N_{L0}; Spatial) as to the pixel group N_{L0} on the L0 reference frame, and residual energy SAD(N_{L1}; Spatial) as to the pixel group N_{L1} on the L1 reference frame to calculate residual energy SAD(Spatial). At this time, the above-mentioned Expression (7) is employed.

In step S74, the TDM residual energy calculating unit 92 uses the motion vector according to the temporal direct mode to calculate residual energy SAD(Temporal), and outputs the calculated residual energy SAD(Temporal) to the comparing unit 93.

Specifically, the TDM residual energy calculating unit 92 obtains pixel groups N_{L0} and N_{L1} on each reference frame corresponding to a peripheral pixel group N_{CUR} of the object block to be encoded, specified by the motion vector directmv_{L0} (Temporal) and motion vector directmv_{L1} (Temporal). The TDM residual energy calculating unit 92 uses the pixel values of the peripheral pixel group N_{CUR} of the object block, and the pixel values of the obtained pixel groups N_{L0} and N_{L1} on each reference frame to calculate the corresponding residual energies using SAD.

Further, the TDM residual energy calculating unit 92 uses residual energy SAD(N_{L0}; Temporal) as to the pixel group N_{L0} on the L0 reference frame, and residual energy SAD(N_{L1}; Temporal) as to the pixel group N_{L1} on the L1 reference frame to calculate residual energy SAD(Temporal). At this time, the above-mentioned Expression (8) is employed.

In step S75, the comparing unit 93 performs comparison between the residual energy SAD(Spatial) based on the spatial direct mode, and the residual energy SAD(Temporal) based on the temporal direct mode, and outputs the result thereof to the direct mode determining unit 94.

In the event that determination is made in step S75 that SAD(Spatial) is equal to or smaller than SAD(Temporal), the processing proceeds to step S76. In step S76, the direct mode determining unit 94 determines to select the spatial direct mode as the optimal direct mode as to the object block. It is output to the motion prediction/compensation unit 73 that the spatial direct mode has been selected as to the object block, as information indicating the type of the direct mode.

On the other hand, in the event that determination is made in step S75 that SAD(Spatial) is greater than SAD(Temporal), the processing proceeds to step S77. In step S77, the direct mode determining unit 94 determines to select the temporal direct mode as the optimal direct mode as to the object block. It is output to the motion prediction/compensation unit 73 that the temporal direct mode has been selected as to the object block, as information indicating the type of the direct mode.

In step S78, the motion prediction/compensation unit 75 calculates the cost function value shown in the above-mentioned Expression (10) or Expression (11) as to the selected direct mode based on information indicating the type of the direct mode from the direct mode determining unit 94. The cost function value calculated here is employed at the time of determining the optimal inter prediction mode in the above-mentioned step S34 in FIG. 8.

Description of Temporal Direct Mode

FIG. 12 is a diagram for describing the temporal direct mode according to the H.264/AVC system.

With the example in FIG. 12, temporal axis t represents elapse of time, an L0 (List0) reference picture, the object picture to be encoded from now on, and an L1 (List1) reference picture are shown from the left in order. Note that, with the H.264/AVC system, the row of the L0 reference picture, object picture, and L1 reference picture is not restricted to this order.

The object block of the object picture is included in a B slice, for example. The TDM motion vector calculating unit 82 calculates motion vector information based on the temporal direct mode as to the L0 reference picture and L1 reference picture.

With the L0 reference picture, motion vector information mv_{col} in a co-located block that is a block positioned in the same spatial address (coordinates) as the object block to be encoded from now on is calculated based on the L0 reference picture and L1 reference picture.

Now, let us say that distance on the temporal axis between the object picture and L0 reference picture is taken as TD_{B}, and distance on the temporal axis between the L0 reference picture and L1 reference picture is taken as TD_{D}. In this case, the L0 motion vector information mv_{L0} in the object picture, and the L1 motion vector information mv_{L1} in the object picture can be calculated with the following Expression (13).

$$\begin{matrix}[ Mathematical Expression 5 ] & \\ {mv}_{L 0} = \frac{{TD}_{B}}{{TD}_{D}} {mv}_{col} \\ {mv}_{L 1} = \frac{{TD}_{D} - {TD}_{B}}{{TD}_{D}} {mv}_{col} & ( 13 )\end{matrix}$$

Note that, with the H.264/AVC system, there is no information equivalent to distances TD_{B} and TD_{D} on the temporal axis t as to the object picture within the compressed image. Accordingly, POC (Picture Order Count) that is information indicating the output sequence of pictures is employed as the actual values of the distances TD_{B} and TD_{D}.

Example of Residual Energy Calculation

FIG. 13 is a diagram for describing residual energy calculation at the SDM residual energy calculating unit 91 and TDM residual energy calculating unit 92. Note that, with the example in FIG. 13, the spatial direct motion vector and temporal direct motion vector will be referred to as direct motion vector collectively. Specifically, with regard to both of the spatial direct motion vector and temporal direct mode vector, residual energy calculation is executed as follows.

In the event of the example in FIG. 13, an L0 (List0) reference picture, the object picture to be encoded from now on, and an L1 (List1) reference picture are shown from the left in order. These are arrayed in the display sequence, but the row of the L0 reference picture, object picture to be encoded from now on, and L1 (List1) reference picture is not restricted to this example in the H.264/AVC system.

With the object picture, the object block (or macro block) to be encoded from now on is shown. With the object block, further a direct motion vector Directmv_{L0} calculated between the object block and the L0 reference picture, and a direct motion vector Directmv_{L1} calculated between the object block and the L1 reference picture are shown.

Here, a peripheral pixel group N_{cur} is an already encoded pixel group around the object block. Specifically, the peripheral pixel group N_{cur} is a pixel group made up of a pixel adjacent to the object block and also already subjected to encoding. Further, specifically, in the event of performing encoding processing in the raster scan sequence, the peripheral pixel group N_{cur} is, as shown in FIG. 13, a pixel group in a region positioned on the left and upper sides of the object block, and is a pixel group with a decoded image being accumulated in the frame memory 72.

Also, the pixel groups N_{L0} and N_{L1} are pixel groups on the L0 and L1 reference pictures corresponding to the peripheral pixel group N_{cur} specified by the motion vector Directmv_{L0} and motion vector Directmv_{L1}.

The SDM residual energy calculating unit 91 and TDM residual energy calculating unit 92 calculate residual energy SAD(N_{L0}; Spatial), SAD(N_{L1}; Spatial), SAD(N_{L0}; Temporal), and SAD(N_{L1}; Temporal) between the peripheral pixel group N_{cur}, and each of the pixel groups N_{L0} and N_{L1} using SAD, respectively. The SDM residual energy calculating unit 91 and TDM residual energy calculating unit 92 then calculate the residual energy SAD(Spatial) and SAD(Temporal) by the above-mentioned Expression (7) and Expression (8), respectively.

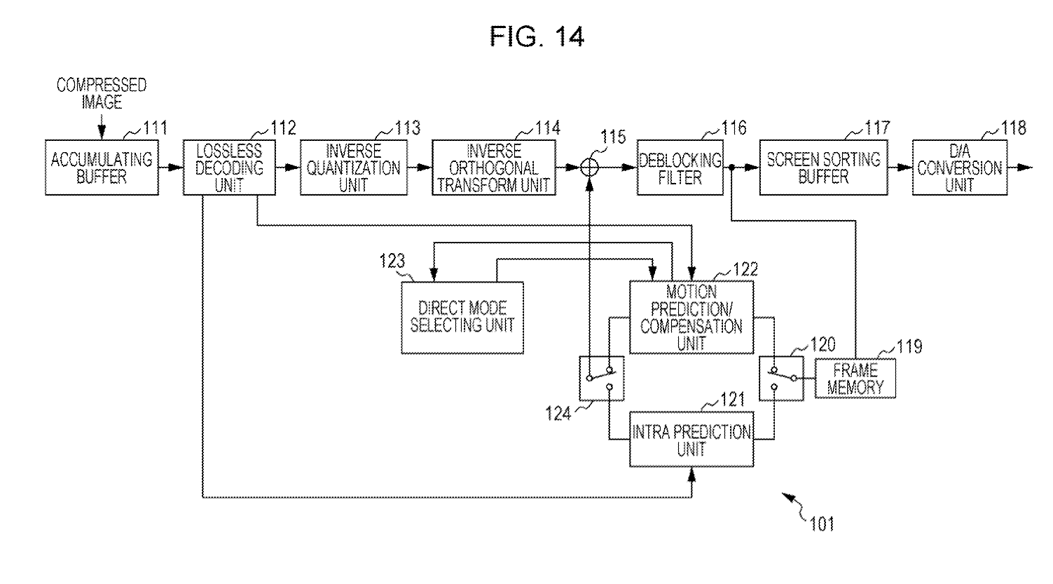

In this way, the residual energy calculation processing is calculation employing the information of an encoded image (i.e., decoded image) instead of raw image information serving as input, whereby the same operation can be performed on the decoding side. Also, the above-mentioned calculation of motion vector information based on the spatial direct mode, and the motion vector information based on the temporal direct mode is similarly calculation employing a decoded image, whereby the same operation can also be performed at the image decoding device 101 in FIG. 14.

Accordingly, information indicating the direct mode for each slice has to be transmitted in a conventional manner, but which direct mode of the spatial and temporal direct modes is employed for each block (or macro block) to be encoded, i.e., information thereof does not need to be transmitted to the decoding side.

Thus, the optimal direct mode can be selected for each object block (or macro block) without increasing the information amount of compressed image information serving as output, and prediction precision can be improved. As a result thereof, encoding efficiency can be improved.

An encoded compressed image is transmitted via a predetermined transmission path, and decoded by the image decoding device.

Configuration Example of Image Decoding Device

FIG. 14 represents the configuration of an embodiment of an image decoding device serving as the image processing device to which the present invention has been applied.

An image decoding device 101 is configured of an accumulating buffer 111, a lossless decoding unit 112, an inverse quantization unit 113, an inverse orthogonal transform unit 114, a computing unit 115, a deblocking filter 116, a screen sorting buffer 117, a D/A conversion unit 118, frame memory 119, a switch 120, an intra prediction unit 121, a motion prediction/compensation unit 122, a direct mode selecting unit 123, and a switch 124.

The accumulating buffer 111 accumulates a transmitted compressed image. The lossless decoding unit 112 decodes information supplied from the accumulating buffer 111 and encoded by the lossless encoding unit 66 in FIG. 1 using a system corresponding to the encoding system of the lossless encoding unit 66. The inverse quantization unit 113 subjects the image decoded by the lossless decoding unit 112 to inverse quantization using a system corresponding to the quantization system of the quantization unit 65 in FIG. 1. The inverse orthogonal transform unit 114 subjects the output of the inverse quantization unit 113 to inverse orthogonal transform using a system corresponding to the orthogonal transform system of the orthogonal transform unit 64 in FIG. 1.

The output subject to inverse orthogonal transform is decoded by being added with the prediction image supplied from the switch 124 by the computing unit 115. The deblocking filter 116 removes the block distortion of the decoded image, then supplies to the frame memory 119 for accumulation, and also outputs to the screen sorting buffer 117.

The screen sorting buffer 117 performs sorting of images. Specifically, the sequence of frames sorted for encoding sequence by the screen sorting buffer 62 in FIG. 1 is resorted in the original display sequence. The D/A conversion unit 118 converts the image supplied from the screen sorting buffer 117 from digital to analog, and outputs to an unshown display for display.

The switch 120 reads out an image to be subjected to inter processing and an image to be referenced from the frame memory 119, outputs to the motion prediction/compensation unit 122, and also reads out an image to be used for intra prediction from the frame memory 119, and supplies to the intra prediction unit 121.

Information indicating the intra prediction mode obtained by decoding the header information is supplied from the lossless decoding unit 112 to the intra prediction unit 121. The intra prediction unit 121 generates, based on this information, a prediction image, and outputs the generated prediction image to the switch 124.

The information (prediction mode information, motion vector information, and reference frame information) obtained by decoding the header information is supplied from the lossless decoding unit 112 to the motion prediction/compensation unit 122. In the event that information indicating the inter prediction mode has been supplied, the motion prediction/compensation unit 122 subjects the image to motion prediction and compensation processing based on the motion vector information and reference frame information to generate a prediction image.

In the event that information indicating the direct mode has been supplied, the motion prediction/compensation unit 122 calculates the motion vector information in the spatial direct mode and temporal direct mode, and outputs the calculated motion vector information to the direct mode selecting unit 123. Also, the motion prediction/compensation unit 122 performs compensation processing in the direct mode selected by the direct mode selecting unit 123 to generate a prediction image.

Note that, in the event of performing motion prediction and compensation processing according to the direct mode, the motion prediction/compensation unit 122 is configured, in the same way as the motion prediction/compensation unit 75 in FIG. 6, so as to include at least the SDM motion vector calculating unit 81 and TDM motion vector calculating unit 82.

The motion prediction/compensation unit 122 then outputs either the prediction image generated in the inter prediction mode or the prediction image generated in the direct mode to the switch 124 according to the prediction mode information.

The direct mode selecting unit 123 uses the motion vector information according to the spatial direct mode and temporal direct mode from the motion prediction/compensation unit 122 to calculate residual energy, respectively. At this time, a peripheral pixel adjacent to the object block to be encoded with a predetermined positional relation and also included in a decoded image is employed for calculation of residual energy.

The direct mode selecting unit 123 compares the two types of residual energies according to the spatial direct mode and temporal direct mode to determine selection of the direct mode having less residual energy, and outputs information indicating the type of the selected direct mode to the motion prediction/compensation unit 122.

Note that the direct mode selecting unit 123 is configured basically in the same way as the direct mode selecting unit 76, and accordingly, the above-mentioned FIG. 6 will also be employed for description of the direct mode selecting unit 123. Specifically, the direct mode selecting unit 123 is configured of, in the same way as the direct mode selecting unit 76 in FIG. 6, an SDM residual energy calculating unit 91, a TDM residual energy calculating unit 92, a comparing unit 93, and a direct mode determining unit 94.

The switch 124 selects the prediction image generated by the motion prediction/compensation unit 122 or intra prediction unit 121, and supplies to the computing unit 115.

Description of Decoding Processing of Image Decoding Device

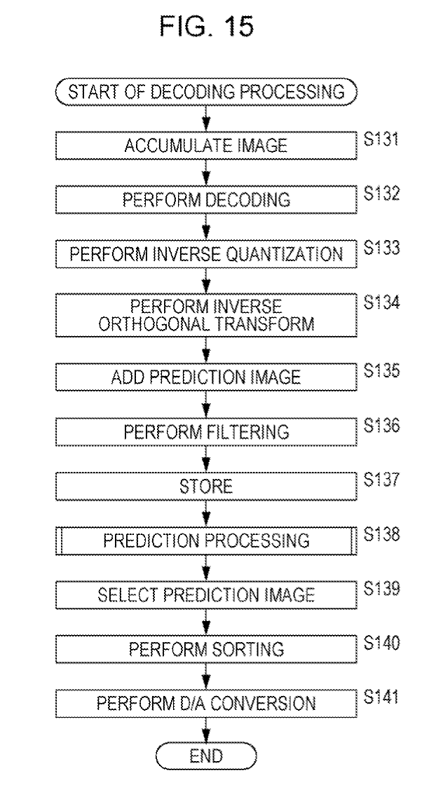

Next, the decoding processing that the image decoding device 101 executes will be described with reference to the flowchart in FIG. 15.

In step S131, the accumulating buffer 111 accumulates the transmitted image. In step S132, the lossless decoding unit 112 decodes the compressed image supplied from the accumulating buffer 111. Specifically, the I picture, P picture, and B picture encoded by the lossless encoding unit 66 in FIG. 1 are decoded.

At this time, the motion vector information, reference frame information, prediction mode information (information indicating the intra prediction mode, inter prediction mode, or direct mode), and flag information are also decoded.

Specifically, in the event that the prediction mode information is intra prediction mode information, the prediction mode information is supplied to the intra prediction unit 121. In the event that the prediction mode information is inter prediction mode information, motion vector information corresponding to the prediction mode information is supplied to the motion prediction/compensation unit 122. In the event that the prediction mode information is the direct mode information, the prediction mode information is supplied to the motion prediction/compensation unit 122.

In step S133, the inverse quantization unit 113 inversely quantizes the transform coefficient decoded by the lossless decoding unit 112 using a property corresponding to the property of the quantization unit 65 in FIG. 1. In step S134, the inverse orthogonal transform unit 114 subjects the transform coefficient inversely quantized by the inverse quantization unit 113 to inverse orthogonal transform using a property corresponding to the property of the orthogonal transform unit 64 in FIG. 1. This means that difference information corresponding to the input of the orthogonal transform unit 64 in FIG. 1 (the output of the computing unit 63) has been decoded.

In step S135, the computing unit 115 adds the prediction image selected in the processing in later-described step S141 and input via the switch 124, to the difference information. Thus, the original image is decoded. In step S136, the deblocking filter 116 subjects the image output from the computing unit 115 to filtering. Thus, block distortion is removed. In step S137, the frame memory 119 stores the image subjected to filtering.

In step S138, the intra prediction unit 121, motion prediction/compensation unit 122, or direct mode selecting unit 123 performs the corresponding image prediction processing in response to the prediction mode information supplied from the lossless decoding unit 112.

Specifically, in the event that the intra prediction mode information has been supplied from the lossless decoding unit 112, the intra prediction unit 121 performs the intra prediction processing in the intra prediction mode. In the event that the inter prediction mode information has been supplied from the lossless decoding unit 112, the motion prediction/compensation unit 122 performs the motion prediction and compensation processing in the inter prediction mode. Also, in the event that the direct mode information has been supplied from the lossless decoding unit 112, the motion prediction/compensation unit 122 performs motion prediction in the spatial and temporal direct modes, and performs compensation processing using the direct mode selected by the direct mode selecting unit 123.

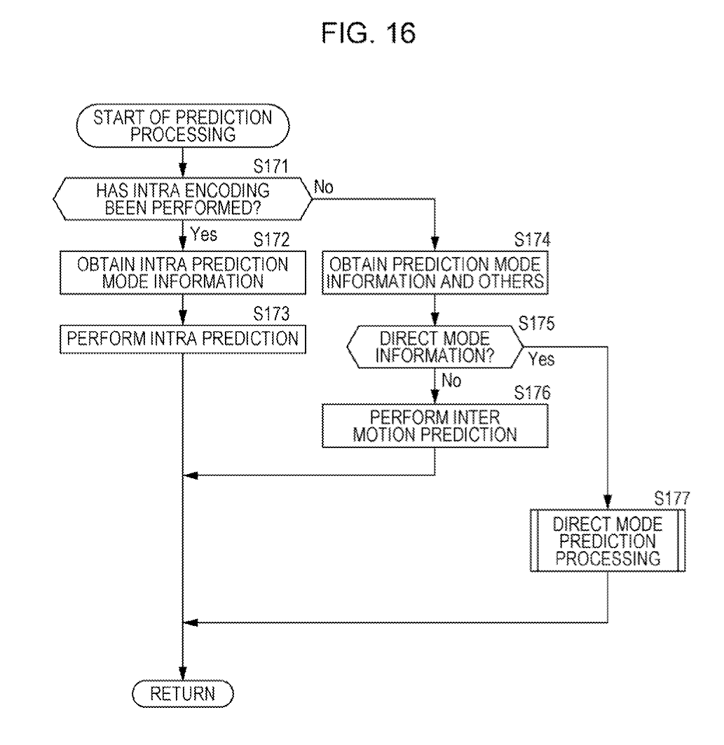

The details of the prediction processing in step S138 will be described later with reference to FIG. 16, but according to this processing, the prediction image generated by the intra prediction unit 121 or the prediction image generated by the motion prediction/compensation unit 122 is supplied to the switch 124.

In step S139, the switch 124 selects the prediction image. Specifically, the prediction image generated by the intra prediction unit 121 or the prediction image generated by the motion prediction/compensation unit 122 is supplied. Accordingly, the supplied prediction image is selected, supplied to the computing unit 115, and in step. S134, as described above, added to the output of the inverse orthogonal transform unit 114.

In step S140, the screen sorting buffer 117 performs sorting. Specifically, the sequence of frames sorted for encoding by the screen sorting buffer 62 of the image encoding device 51 is sorted in the original display sequence.

In step S141, the D/A conversion unit 118 converts the image from the screen sorting buffer 117 from digital to analog. This image is output to an unshown display, and the image is displayed.

Description of Prediction Processing of Image Decoding Device

Next, the prediction processing in step S138 in FIG. 15 will be described with reference to the flowchart in FIG. 16.

In step S171, the intra prediction unit 121 determines whether or not the object block has been subjected to intra encoding. Upon the intra prediction mode information being supplied from the lossless decoding unit 112 to the intra prediction unit 121, in step S171 the intra prediction unit 121 determines that the object block has been subjected to intra encoding, and the processing proceeds to step S172.

In step S172, the intra prediction unit 121 obtains the intra prediction mode information, and in step S173 performs intra prediction.

Specifically, in the event that the image to be processed is an image to be subjected to intra processing, the necessary image is read out from the frame memory 119, and supplied to the intra prediction unit 121 via the switch 120. In step S173, the intra prediction unit 121 performs intra prediction in accordance with the intra prediction mode information obtained in step S172 to generate a prediction image. The generated prediction image is output to the switch 124.

On the other hand, in the event that determination is made in step S171 that intra encoding has not been performed, the processing proceeds to step S174.

In step S174, the motion prediction/compensation unit 122 obtains the prediction mode information and so forth from the lossless decoding unit 112.

In the event that the image to be processed is an image to be subjected to inter processing, the inter prediction mode information, reference frame information, and motion vector information are supplied from the lossless decoding unit 112 to the motion prediction/compensation unit 122. In this case, in step S174, the motion prediction/compensation unit 122 obtains the inter prediction mode information, reference frame information, and motion vector information.

In step S175, the motion prediction/compensation unit 122 determines whether or not the prediction mode information from the lossless decoding unit 112 is direct mode information. In the event that determination is made in step S175 that the prediction mode information is not direct mode information, i.e., the prediction mode information is inter prediction mode information, the processing proceeds to step S176.

In step S176, the motion prediction/compensation unit 122 performs inter motion prediction. Specifically, in the event that the image to be processed is an image to be subjected to inter prediction processing, the necessary image is read out from the frame memory 119, and supplied to the motion prediction/compensation unit 122 via the switch 120. In step S176, the motion prediction/compensation unit 122 performs motion prediction in the inter prediction mode based on the motion vector obtained in step S174 to generate a prediction image. The generated prediction image is output to the switch 124.

On the other hand, in the event that the image to be processed is an image to be processed in the direct mode, the direct mode information is supplied from the lossless decoding unit 112 to the motion prediction/compensation unit 122. In this case, in step S174 the motion prediction/compensation unit 122 obtains the direct mode information, determination is made in step S175 that the prediction mode information is the direct mode information, and the processing proceeds to step S177.

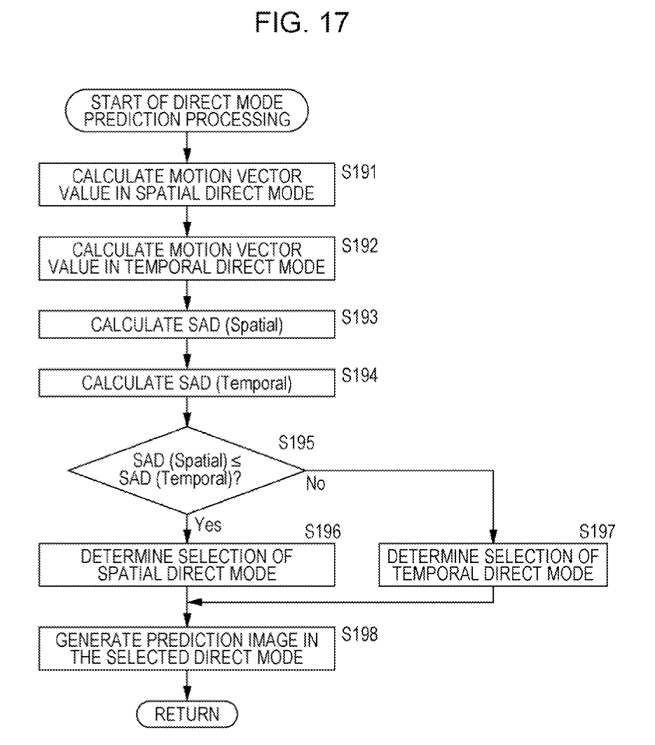

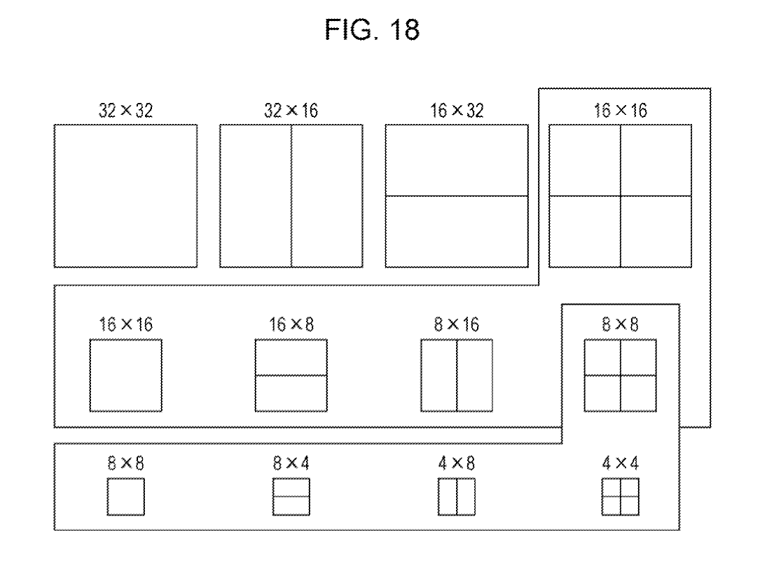

In step S177, the motion prediction/compensation unit 122 and direct mode selecting unit 123 perform direct mode prediction processing. The direct mode prediction processing in step S175 will be described with reference to FIG. 17.

Description of Direct Mode Prediction Processing of Image Decoding Device

FIG. 17 is a flowchart for describing the direct mode prediction processing. Note that, with the processing in steps S193 through S197 in FIG. 17, basically the same processing as the processing in steps S73 through S77 in FIG. 11 is performed, and accordingly, description thereof is redundant, and detailed description thereof will be omitted.

In step S191, the SDM motion vector calculating unit 81 of the motion prediction/compensation unit 122 calculates the motion vector in the spatial direct mode. That is to say, the SDM motion vector calculating unit 81 performs motion prediction based on the spatial direct mode.

At this time, with the SDM motion vector calculating unit 81, based on the spatial direct mode, the motion vector directmv_{L0} (Spatial) is calculated with motion prediction between the object frame and the L0 reference frame. Similarly, the motion vector directmv_{L1} (Spatial) is calculated with motion prediction between the object frame and the L1 reference frame. The calculated motion vector directmv_{L0} (Spatial) and motion vector directmv_{L1} (Spatial) are output to the SDM residual energy calculating unit 91.

In step S192, the TDM motion vector calculating unit 82 of the motion prediction/compensation unit 122 calculates the motion vector in the temporal direct mode. That is to say, the TDM motion vector calculating unit 82 performs motion prediction based on the temporal direct mode.

At this time, with the TDM motion vector calculating unit 82, based on the temporal direct mode, the motion vector directmv_{L0} (Temporal) is calculated with motion prediction between the object frame and the L0 reference frame. Similarly, the motion vector directmv_{L1} (Temporal) is calculated with motion prediction between the object frame and the L1 reference frame. The calculated motion vector directmv_{L0} (Temporal) and motion vector directmv_{L1} (Temporal) are output to the TDM residual energy calculating unit 92.

In step S193, the SDM residual energy calculating unit 91 of the direct mode selecting unit 123 uses the motion vector according to the spatial direct mode to calculate residual energy SAD(Spatial). The SDM residual energy calculating unit 91 outputs the calculated residual energy SAD(Spatial) to the comparing unit 93.

Specifically, the SDM residual energy calculating unit 91 obtains pixel groups N_{L0} and N_{L1} on each reference frame corresponding to a peripheral pixel group N_{CUR} of the object block to be encoded, specified by the motion vector directmv_{L0} (Spatial) and motion vector directmv_{L1} (Spatial). The SDM residual energy calculating unit 91 uses the pixel values of the peripheral pixel group N_{CUR} of the object block, and the pixel values of the obtained pixel groups N_{L0} and N_{L1} on each reference frame to calculate the corresponding residual energies using SAD.

Further, the SDM residual energy calculating unit 91 uses residual energy SAD(N_{L0}; Spatial) as to the pixel group N_{L0} on the L0 reference frame, and residual energy SAD(N_{L1}; Spatial) as to the pixel group N_{L1} on the L1 reference frame to calculate residual energy SAD(Spatial). At this time, the above-mentioned Expression (7) is employed.

In step S194, the TDM residual energy calculating unit 92 of the direct mode selecting unit 123 uses the motion vector according to the temporal direct mode to calculate residual energy SAD(Temporal), and outputs the calculated residual energy SAD(Temporal) to the comparing unit 93.

Specifically, the TDM residual energy calculating unit 92 obtains pixel groups N_{L0} and N_{L1} on each reference frame corresponding to a peripheral pixel group N_{CUR} of the object block to be encoded, specified by the motion vector directmv_{L0} (Temporal) and motion vector directmv_{L1} (Temporal). The TDM residual energy calculating unit 92 uses the pixel values of the peripheral pixel group N_{CUR} of the object block, and the pixel values of the obtained pixel groups N_{L0} and N_{L1} on each reference frame to calculate the corresponding residual energies using SAD.

Further, the DM residual energy calculating unit 92 uses residual energy SAD(N_{L0}; Temporal) as to the pixel group N_{L0} on the L0 reference frame, and residual energy SAD(N_{L1}; Temporal) as to the pixel group N_{L1} on the L1 reference frame to calculate residual energy SAD(Temporal). At this time, the above-mentioned Expression (8) is employed.

In step S195, the comparing unit 93 of the direct mode selecting unit 123 performs comparison between the residual energy SAD(Spatial) based on the spatial direct mode, and the residual energy SAD(Temporal) based on the temporal direct mode, and outputs the result thereof to the direct mode determining unit 94 of the direct mode selecting unit 123.

In the event that determination is made in step S195 that SAD(Spatial) is equal to or smaller than SAD(Temporal), the processing proceeds to step S196. In step S196; the direct mode determining unit 94 determines to select the spatial direct mode as the optimal direct mode as to the object block. It is output to the motion prediction/compensation unit 122 that the spatial direct mode has been selected as to the object block, as information indicating the type of the direct mode.

On the other hand, in the event that determination is made in step S195 that SAD(Spatial) is greater than SAD(Temporal), the processing proceeds to step S197. In step S197, the direct mode determining unit 94 determines to select the temporal direct mode as the optimal direct mode as to the object block. It is output to the motion prediction/compensation unit 122 that the temporal direct mode has been selected as to the object block, as information indicating the type of the direct mode.

In step S198, the motion prediction/compensation unit 122 generates a prediction image in the selected direct mode based on information indicating the type of the direct mode from the direct mode determining unit 94. That is to say, the motion prediction/compensation unit 122 performs compensation processing using the motion vector information in the selected direct mode to generate a prediction image. The generated prediction image is supplied to the switch 124.,

As described above, selection of the optimal direct mode has been performed at both of the image encoding device and the image decoding device using a decoded image for each object block (or macro block). Thus, image quality with high quality can be displayed without transmitting information indicating the type of the direct mode for each object block (or macro block).

That is to say, the type of the direct mode for each object block can be switched without causing increase in compressed information, and accordingly, prediction precision can be improved.

Note that description has been made so far regarding a case where the size of a macro blocks is 16×16 pixels, but the present invention may be applied to an extended macro block size described in “Video Coding Using Extended Block Sizes”, VCEG-AD09, ITU-Telecommunications Standardization Sector STUDY GROUP Question 16—Contribution 123, January 2009.

FIG. 18 is a diagram illustrating an example of an extended macro block size. With the above-mentioned description, the macro block size is extended up to 32×32 pixels.

Macro blocks made up of 32×32 pixels divided into blocks (partitions) of 32×32 pixels, 32×16 pixels, 16×32 pixels, and 16×16 pixels are shown from the left in Order on the upper tier in FIG. 18. Blocks made up of 16×16 pixels divided into blocks of 16×16 pixels, 16×8 pixels, 8×16 pixels, and 8×8 pixels are shown from the left in order on the middle tier in FIG. 18. Also, blocks made up of 8×8 pixels divided into blocks of 8×8 pixels, 8×4 pixels, 4×8 pixels, and 4×4 pixels are shown from the left in order on the lower tier in FIG. 18.

In other words, the macro blocks of 32×32 pixels may be processed with blocks of 32×32 pixels, 32×16 pixels, 16×32 pixels, and 16×16 pixels shown on the upper tier in FIG. 18.

Also, the blocks of 16×16 pixels shown on the right side on the upper tier may be processed with blocks of 16×16 pixels, 16×8 pixels, 8×16 pixels, and 8×8 pixels shown on the middle tier in the same way as with the H.264/AVC system.

Further, the blocks of 8×8 pixels shown on the right side on the middle tier may be processed with blocks of 8×8 pixels, 8×4 pixels, 4×8 pixels, and 4×4 pixels shown on the lower tier in the same way as with the H.264/AVC system.

With the extended macro block sizes, by employing such a hierarchical structure, regarding a 16×16-pixel block or less, a greater block is defined as a superset thereof while maintaining compatibility with the H.264/AVC system.

The present invention may also be applied to the proposed macro block sizes extended as described above.

Description has been made so far with the H.264/AVC system employed as an encoding system, but another encoding system/decoding system may be employed.

Note that the present invention may be applied to an image encoding device and an image decoding device used at the time of receiving image information (bit streams) compressed by orthogonal transform such as discrete cosine transform or the like and motion compensation via a network medium such as satellite broadcasting, a cable television, the Internet, a cellular phone, or the like, for example, as with MPEG, H.26x, or the like. Also, the present invention may be applied to an image encoding device and an image decoding device used at the time of processing on storage media such as an optical disc, a magnetic disk, and flash memory. Further, the present invention may be applied to a motion prediction compensation device included in such an image encoding device and an image decoding device and so forth.

The above-mentioned series of processing may be executed by hardware, or may be executed by software. In the event of executing the series of processing by software, a program making up the software thereof is installed in a computer. Here, examples of the computer include a computer built into dedicated hardware, and a general-purpose personal computer whereby various functions can be executed by various types of programs being installed thereto.

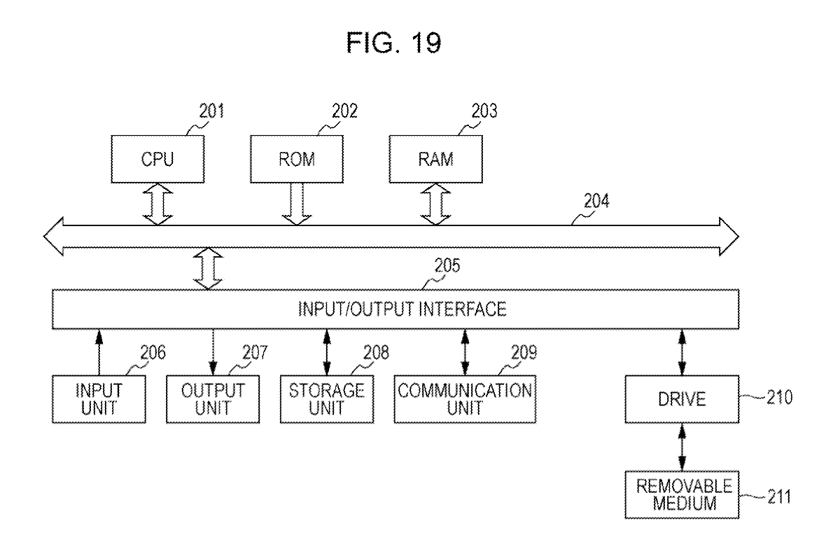

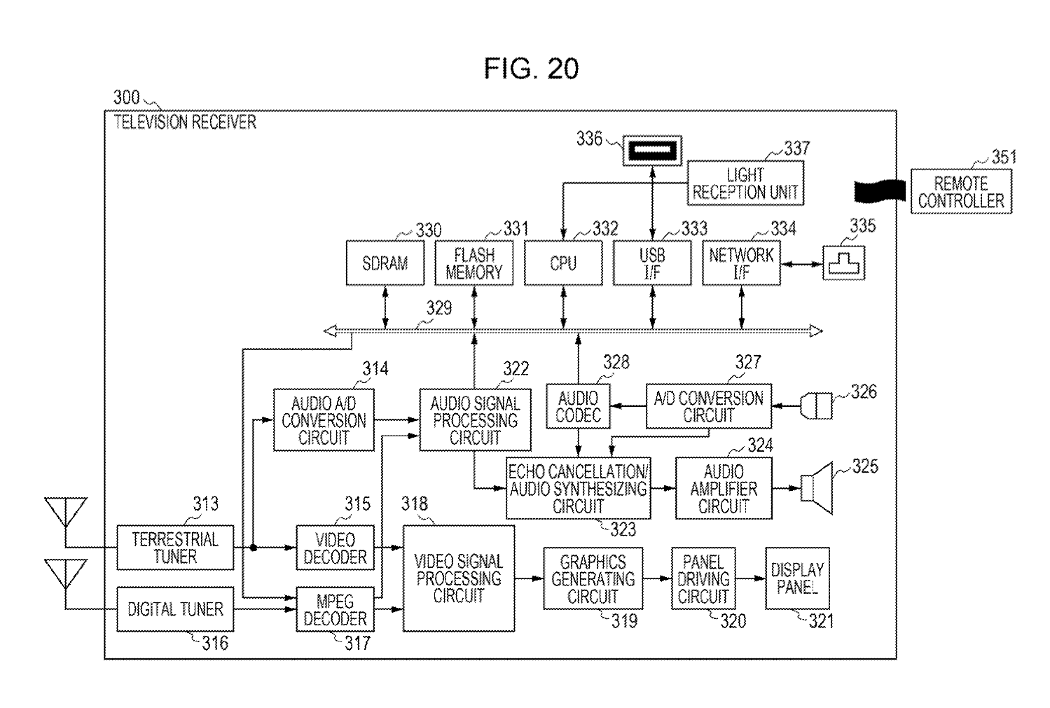

FIG. 19 is a block diagram illustrating a configuration example of the hardware of a computer which executes the above-mentioned series of processing using a program.

With the computer, a CPU Central Processing Unit) 201, ROM (Read Only Memory) 202, and RAM (Random Access Memory) 203 are mutually connected by a bus 204.

Further, an input/output interface 205 is connected to the bus 204. An input unit 206, an output unit 207, a storage unit 208, a communication unit 209, and a drive 210 are, connected to the input/output interface 205.

The input unit 206 is made up of a keyboard, a mouse, a microphone, and so forth. The output unit 207 is made up of a display, a speaker, and so forth. The storage unit 208 is made up of a hard disk, nonvolatile memory, and so forth. The communication unit 209 is made up of a network interface and so forth. The drive 210 drives a removable medium 211 such as a magnetic disk, an optical disc, a magneto-optical disk, semiconductor memory, or the like.

With the computer thus configured, for example, the CPU 201 loads a program stored in the storage unit 208 to the RAM 203 via the input/output interface 205 and bus 204, and executes the program, and accordingly, the above-mentioned series of processing is performed.

The program that the computer (CPU 201) executes may be provided by being recorded in the removable medium 211 serving as a package medium or the like, for example. Also, the program may be provided via a cable or wireless transmission medium such as a local area network, the Internet, or digital broadcasting.

With the computer, the program may be installed in the storage unit 208 via, the input/output interface 205 by mounting the removable medium 211 on the drive 210. Also, the program may be received by the communication unit 209 via a cable or wireless transmission medium, and installed in the storage unit 208. Additionally; the program may be installed in the ROM 202 or storage unit 208 beforehand.

Note that the program that the computer executes may be a program wherein the processing is performed in the time sequence along the sequence described in the present Specification, or may be a program wherein the processing is performed in parallel or at necessary timing such as when call-up is performed.

The embodiments of the present invention are not restricted to the above-mentioned embodiment, and various modifications may be made without departing from the essence of the present invention.

For example, the above-mentioned image encoding device 51 and image decoding device 101 may be applied to an optional electronic device. Hereafter, an example thereof will be described.

FIG. 20 is a block diagram illustrating a principal configuration example of a television receiver using the image decoding device to which the present invention has been applied.

A television receiver 300 shown in FIG. 20 includes a terrestrial tuner 313, a video decoder 315, a video signal processing circuit 318, a graphics generating circuit 319, a panel driving circuit 320, and a display panel 321.

The terrestrial tuner 313 receives the broadcast wave signals of a terrestrial analog broadcast via an antenna, demodulates, obtains video signals, and supplies these to the video decoder 315. The video decoder 315 subjects the video signals supplied from the terrestrial tuner 313 to decoding processing, and supplies the obtained digital component signals to the video signal processing circuit 318.

The video signal processing circuit 318 subjects the video data supplied from the video decoder 315 to predetermined processing such as noise removal or the like, and supplies the obtained video data to the graphics generating circuit 319.

The graphics generating circuit 319 generates the video data of a program to be displayed on a display panel 321, or image data due to processing based on an application to be supplied via a network, or the like, and supplies the generated video data or image data to the panel driving circuit 320. Also, the graphics generating circuit 319 also performs processing such as supplying video data obtained by generating video data (graphics) for the user displaying a screen used for selection of an item or the like, and superimposing this on the video data of a program, to the panel driving circuit 320 as appropriate.

The panel driving circuit 320 drives the display panel 321 based on the data supplied from the graphics generating circuit 319 to display the video of a program, or the above-mentioned various screens on the display panel 321.

The display panel 321 is made up of an LCD (Liquid Crystal Display) and so forth, and displays the video of a program or the like in accordance with the control by the panel driving circuit 320.

Also, the television receiver 300 also includes an audio A/D (Analog/Digital) conversion circuit 314, an audio signal processing circuit 322, an echo cancellation/audio synthesizing circuit 323, an audio amplifier circuit 324, and a speaker 325.

The terrestrial tuner 313 demodulated the received broadcast wave signal, thereby obtaining not only a video signal but also an audio signal. The terrestrial tuner 313 supplies the obtained audio signal to the audio A/D conversion circuit 314.

The audio A/D conversion circuit 314 subjects the audio signal supplied from the terrestrial tuner 313 to A/D conversion processing, and supplies the obtained digital audio signal to the audio signal processing circuit 322.

The audio signal processing circuit 322 subjects the audio data supplied from the audio A/D conversion circuit 314 to predetermined processing such as noise removal or the like, and supplies the obtained audio data to the echo cancellation/audio synthesizing circuit 323.

The echo cancellation/audio synthesizing circuit 323 supplies the audio data supplied from the audio signal processing circuit 322 to the audio amplifier circuit 324.

The audio amplifier circuit 324 subjects the audio data supplied from the echo cancellation/audio synthesizing circuit 323 to D/A conversion processing, subjects to amplifier processing to adjust to predetermined volume, and then outputs the audio from the speaker 325.

Further, the television receiver 300 also includes a digital tuner 316, and an MPEG decoder 317.

The digital tuner 316 receives the broadcast wave signals of a digital broadcast (terrestrial digital broadcast, BS (Broadcasting Satellite)/CS (Communications Satellite) digital broadcast) via the antenna, demodulates to obtain MPEG-TS (Moving Picture Experts Group-Transport Stream), and supplies this to the MPEG decoder 317.

The MPEG decoder 317 descrambles the scrambling given to the MPEG-TS supplied from the digital tuner 316, and extracts a stream including the data of a program serving as a playback object (viewing object). The MPEG decoder 317 decodes an audio packet making up the extracted stream, supplies the obtained audio data to the audio signal processing circuit 322, and also decodes a video packet making up the stream, and supplies the obtained video data to the video signal processing circuit 318. Also, the MPEG decoder 317 supplies EPG (Electronic Program Guide) data extracted from the MPEG-TS to a CPU 332 via an unshown path.

The television receiver 300 uses the above-mentioned image decoding device 101 as the MPEG decoder 317 for decoding video packets in this way. Accordingly, the MPEG decoder 317 performs selection of the optimal direct mode for each object block (or macro block) using a decoded image in the same way as with the case of the image decoding device 101. Thus, increase in compressed information can be suppressed, and also prediction precision can be improved.

The video data supplied from the MPEG decoder 317 is, in the same way as with the case of the video data supplied from the video decoder 315, subjected to predetermined processing at the video signal processing circuit 318. The video data subjected to predetermined processing is then superimposed as appropriate on the generated video data and so forth at the graphics generating circuit 319, supplied to the display panel 321 via the panel driving circuit 320, and the image thereof is displayed thereon.

The audio data supplied from the MPEG decoder 317 is, in the same way as with the case of the audio data supplied from the audio A/D conversion circuit 314, subjected to predetermined processing at the audio signal processing circuit 322. The audio data subjected to predetermined processing is then supplied to the audio amplifier circuit 324 via the echo cancellation/audio synthesizing circuit 323, and subjected to D/A conversion processing and amplifier processing. As a result thereof, the audio adjusted in predetermined volume is output from the speaker 325.

Also, the television receiver 300 also includes a microphone 326, and an A/D conversion circuit 327.

The A/D conversion circuit 327 receives the user's audio signal collected by the microphone 326 provided to the television receiver 300 serving as for audio conversation. The A/D conversion circuit 327 subjects the received audio signal to A/D conversion processing, and supplies the obtained digital audio data to the echo cancellation/audio synthesizing circuit 323.

In the event that the user (user A)'s audio data of the television receiver 300 has been supplied from the A/D conversion circuit 327, the echo cancellation/audio synthesizing circuit 323 perform echo cancellation with the user A's audio data taken as an object. After echo cancellation, the echo cancellation/audio synthesizing circuit 323 outputs audio data obtained by synthesizing with other audio data and so forth, from the speaker 325 via the audio amplifier circuit 324.

Further, the television receiver 300 also includes an audio codec 328, an, internal bus 329, SDRAM (Synchronous Dynamic Random Access Memory) 330, flash memory 331, a CPU 332, a USB (Universal Serial Bus) I/F 333, and a network I/F 334.

The A/D conversion circuit 327 receives the user's audio signal collected by the microphone 326 provided to the television receiver 300 serving as for audio conversation. The A/D conversion circuit 327 subjects the received audio signal to A/D conversion processing, and supplies the obtained digital audio data to the audio codec 328.

The audio codec 328 converts the audio data supplied from the A/D conversion circuit 327 into the data of a predetermined format for transmission via a network, and supplies to the network I/F 334 via the internal bus 329.

The network I/F 334 is connected to the network via a cable mounted on a network terminal 335. The network I/F 334 transmits the audio data supplied from the audio codec 328 to another device connected to the network thereof, for example. Also, the network I/F 334 receives, via the network terminal 335, the audio data transmitted from another device connected thereto via the network for example, and supplies this to the audio codec 328 via the internal bus 329.

The audio codec 328 converts the audio data supplied from the network I/F 334 into the data of a predetermined format, and supplies this to the echo cancellation/audio synthesizing circuit 323.

The echo cancellation/audio synthesizing circuit 323 performs echo cancellation with the audio data supplied from the audio codec 328 taken as an object, and outputs the data of audio obtained by synthesizing with other audio data and so forth, from the speaker 325 via the audio amplifier circuit 324.

The SDRAM 330 stores various types of data necessary for the CPU 332 performing processing.

The flash memory 331 stores a program to be executed by the CPU 332. The program stored in the flash memory 331 is read out by the CPU 332 at predetermined timing such as when activating the television receiver 300, or the like. EPG data obtained via a digital broadcast, data obtained from a predetermined server via the network, and so forth are also stored in the flash memory 331.

For example, MPEG-TS including the content data obtained from a predetermined server via the network by the control of the CPU 332 is stored in the flash memory 331. The flash memory 331 supplies the MPEG-TS thereof to the MPEG decoder 317 via the internal bus 329 by the control of the CPU 332, for example.

The MPEG decoder 317 processes the MPEG-TS thereof in the same way as with the case of the MPEG-TS supplied from the digital tuner 316. In this way, the television receiver 300 receives the content data made up of video, audio, and so forth via the network, decodes using the MPEG decoder 317, whereby video thereof can be displayed, and audio thereof can be output.

Also, the television receiver 300 also includes a light reception unit 337 for receiving the infrared signal transmitted from a remote controller 351.

The light reception unit 337 receives infrared rays from the remote controller 351, and outputs a control code representing the content of the user's operation obtained by demodulation, to the CPU 332.

The CPU 332 executes the program stored in the flash memory 331 to control the entire operation of the television receiver 300 according to the control code supplied from the light reception unit 337, and so forth. The CPU 332, and the units of the television receiver 300 are connected via an unshown path.

The USB I/F 333 performs transmission/reception of data as to an external device of the television receiver 300 which is connected via a USB cable mounted on a USB terminal 336. The network I/F 334 connects to the network via a cable mounted on the network terminal 335, also performs transmission/reception of data other than audio data as to various devices connected to the network.

The television receiver 300 uses the image decoding device 101 as the MPEG decoder 317, whereby selection of the optimal direct mode can be performed using a decoded image for each object block (or macro block). As a result thereof, the television receiver 300 can obtain a decoded image with higher precision from broadcast wave signals received via the antenna, or the content data obtained via the network, and display this.

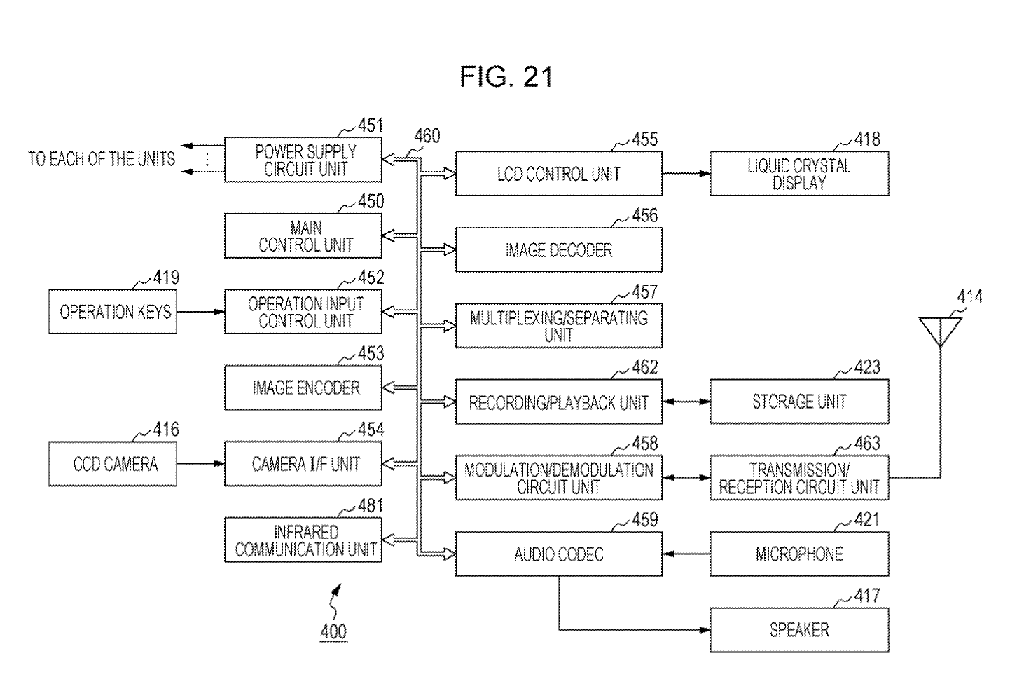

FIG. 21 is a block diagram illustrating a principal configuration example of a cellular phone using the image encoding device and image decoding device to which the present invention has been applied.

A cellular phone 400 shown in FIG. 21 includes a main control unit 450 configured so as to integrally control the units, a power supply circuit unit 451, an operation input control unit 452, an image encoder 453, a camera I/F unit 454, an LCD control unit 455, an image decoder 456, a multiplexing/separating unit 457, a recording/playback unit 462, a modulation/demodulation circuit unit 458, and an audio codec 459. These are mutually connected via a bus 460.

Also, the cellular phone 400 includes operation keys 419, a CCD (Charge Coupled Devices) camera 416, a liquid crystal display 418, a storage unit 423, a transmission/reception circuit unit 463, an antenna 414, a microphone (MIC) 421, and a speaker 417.

Upon a call being ended and a power key being turned on by the user's operation, the power supply circuit unit 451 activates the cellular phone 400 in an operational state by supplying power to the units from a battery pack.

The cellular phone 400 performs various operations such as transmission/reception of an audio signal, transmission/reception of an e-mail and image data, image shooting, data recoding, and so forth, in various modes such as a voice call mode, a data communication mode, and so forth, under control of a main control unit 450 made up of a CPU, ROM, RAM, and so forth.

For example, in the voice call mode, the cellular phone 400 converts the audio signal collected by the microphone (MIC) 421 into digital audio data by the audio codec 459, subjects this to spectrum spread processing at the modulation/demodulation circuit unit 458, subjects this to digital/analog conversion processing and frequency conversion processing at the transmission/reception circuit unit 463. The cellular phone 400 transmits the signal for transmission obtained by the conversion processing thereof to an unshown base station via the antenna 414. The signal for transmission (audio signal) transmitted to the base station is supplied to the communication partner's cellular phone via the public telephone network.

Also, for example, in the voice call mode, the cellular phone 400 amplifies the reception signal received at the antenna 414, at the transmission/reception circuit unit 463, further subjects to frequency conversion processing and analog/digital conversion processing, subjects to spectrum inverse spread processing at the modulation/demodulation circuit unit 458, and converts into an analog audio signal by the audio codec 459. The cellular phone 400 outputs the converted and obtained analog audio signal thereof from the speaker 417.

Further, for example, in the event of transmitting an e-mail in the data communication mode, the cellular phone 400 accepts the text data of the e-mail input by the operation of the operation keys 419 at the operation input control unit 452. The cellular phone 400 processes the text data thereof at the main control unit 450, and displays on the liquid crystal display 418 via the LCD control unit 455 as an image.

Also, the cellular phone 400 generates e-mail data at the main control unit 450 based on the text data accepted by the operation input control unit 452, the user's instructions, and so forth. The cellular phone 400 subjects the e-mail data thereof to spectrum spread processing at the modulation/demodulation circuit unit 458, and subjects to digital/analog conversion processing and frequency conversion processing at the transmission/reception circuit unit 463. The cellular phone 400 transmits the signal for transmission obtained by the conversion processing thereof to an unshown base station via the antenna 414. The signal for transmission (e-mail) transmitted to the base station is supplied to a predetermined destination via the network, mail server, and so forth.

Also, for example, in the event of receiving an e-mail in the data communication mode, the cellular phone 400 receives the signal transmitted from the base station via the antenna 414 with the transmission/reception circuit unit 463, amplifies, and further subjects to frequency conversion processing and analog/digital conversion processing. The cellular phone 400 subjects the reception signal thereof to spectrum inverse spread processing at the modulation/demodulation circuit unit 458 to restore the original e-mail data. The cellular phone 400 displays the restored e-mail data on the liquid crystal display 418 via the LCD control unit 455.

Note that the cellular phone 400 may record (store) the received e-mail data in the storage unit 423 via the recording/playback unit 462.

This storage unit 423 is an optional rewritable storage medium. The storage unit 423 may be, for example, semiconductor memory such as RAM, built-in flash memory, or the like, may be a hard disk, or may be a removable medium such as a magnetic disk, a magneto-optical disk, an optical disc, USB memory, a memory card, or the like. It goes without saying that the storage unit 423 may be other than these.

Further, for example, in the event of transmitting image data in the data communication mode, the cellular phone 400 generates image data by imaging at the CCD camera 416. The CCD camera 416 includes a CCD serving as an optical device such as a lens, diaphragm, and so forth, and serving as a photoelectric device, which images a subject, converts the intensity of received light into an electrical signal, and generates the image data of an image of the subject. The image data thereof is subjected to compression encoding at the image encoder 453 using a predetermined encoding system, for example, such as MPEG2, MPEG4, or the like, via the camera I/F unit 454, and accordingly, the image data thereof is converted into encoded image data.

The cellular phone 400 employs the above-mentioned image encoding device 51 as the image encoder 453 for performing such processing. Accordingly, the image encoder 453 performs selection of the optimal direct mode for each object block (or macro block) using a decoded image in the same way as with the case of the image encoding device 51. Thus, increase in, compressed information can be suppressed, and also prediction precision can be improved.

Note that, at this time simultaneously, the cellular phone 400 converts the audio collected at the microphone (MIC) 421 from analog to digital at the audio codec 459, and further encodes this during imaging by the CCD camera 416.

The cellular phone 400 multiplexes the encoded image data supplied from the image encoder 453, and the digital audio data supplied from the audio codec 459 at the multiplexing/separating unit 457 using a predetermined method. The cellular phone 400 subjects the multiplexed data obtained as a result thereof to spectrum spread processing at the modulation/demodulation circuit unit 458, and subjects to digital/analog conversion processing and frequency conversion processing at the transmission/reception circuit unit 463. The cellular phone 400 transmits the signal for transmission obtained by the conversion processing thereof to an unshown base station via the antenna 414. The signal for transmission (image data) transmitted to the base station is supplied to the communication partner via the network or the like.

Note that in the event that image data is not transmitted, the cellular phone 400 may also display the image data generated at the CCD camera 416 on the liquid crystal display 418 via the LCD control unit 455 instead of the image encoder 453.

Also, for example, in the event of receiving the data of a moving image file linked to a simple website or the like in the data communication mode, the cellular phone 400 receives the signal transmitted from the base station at the transmission/reception circuit unit 463 via the antenna 414, amplifies, and further subjects to frequency conversion processing and analog/digital conversion processing. The cellular phone 400 subjects the received signal to spectrum inverse spread processing at the modulation/demodulation circuit unit 458 to restore the original multiplexed data. The cellular phone 400 separates the multiplexed data thereof at the multiplexing/separating unit 457 into encoded image data and audio data.

The cellular phone 400 decodes the encoded image data at the image decoder 456 using the decoding system corresponding to a predetermined encoding system such as MPEG2, MPEG4, or the like, thereby generating playback moving image data, and displays this on the liquid crystal display 418 via the LCD control unit 455. Thus, moving image data included in a moving image file linked to a simple website is displayed on the liquid crystal display 418, for example.

The cellular phone 400 employs the above-mentioned image decoding device 101 as the image decoder 456 for performing such processing. Accordingly, the image decoder 456 performs selection of the optimal direct mode for each object block (or macro block) using a decoded image in the same way as with the case of the image decoding device 101. Thus, increase in compressed information can be suppressed, and also prediction precision can be improved.

At this time, simultaneously, the cellular phone 400 converts the digital audio data into an analog audio signal at the audio codec 459, and outputs this from the speaker 417. Thus, audio data included in a moving image file linked to a simple website is played, for example.

Note that, in the same way as with the case of e-mail, the cellular phone 400 may record (store) the received data liked to a simple website or the like in the storage unit 423 via the recording/playback unit 462.

Also, the cellular phone 400 analyzes the two-dimensional code obtained by being imaged by the CCD camera 416 at the main control unit 450, whereby information recorded in the two-dimensional code can be obtained.

Further, the cellular phone 400 can communicate with an external device at the infrared communication unit 481 using infrared rays.

The cellular phone 400 employs the image encoding device 51 as the image encoder 453, whereby the encoding efficiency of encoded data to be generated by encoding the image data generated at the CCD camera 416 can be improved, for example. As a result, the cellular phone 400 can provide encoded data (image data) with excellent encoding efficiency to another device.

Also, the cellular phone 400 employs the image decoding device 101 as the image decoder 456, whereby a prediction image with high precision can be generated. As a result thereof, the cellular phone 400 can obtain a decoded image with higher precision from a moving image file linked to a simple website, and display this, for example.

Note that description has been made so far wherein the cellular phone 400 employs the CCD camera 416, but the cellular phone 400 may employ an image sensor (CMOS image sensor) using CMOS (Complementary Metal Oxide Semiconductor) instead of this CCD camera 416. In this case as well, the cellular phone 400 can image a subject and generate the image data of an image of the subject in the same way as with the case of employing the CCD camera 416.

Also, description has been made so far regarding the cellular phone 400, but the image encoding device 51 and image decoding device 101 may be applied to any kind of device in the same way as with the case of the cellular phone 400 as long as it is a device having the same imaging function and communication function as those of the cellular phone 400, for example, such as a PDA (Personal Digital Assistants), smart phone, UMPC (Ultra Mobile Personal Computers), net book, notebook-sized personal computer, or the like.

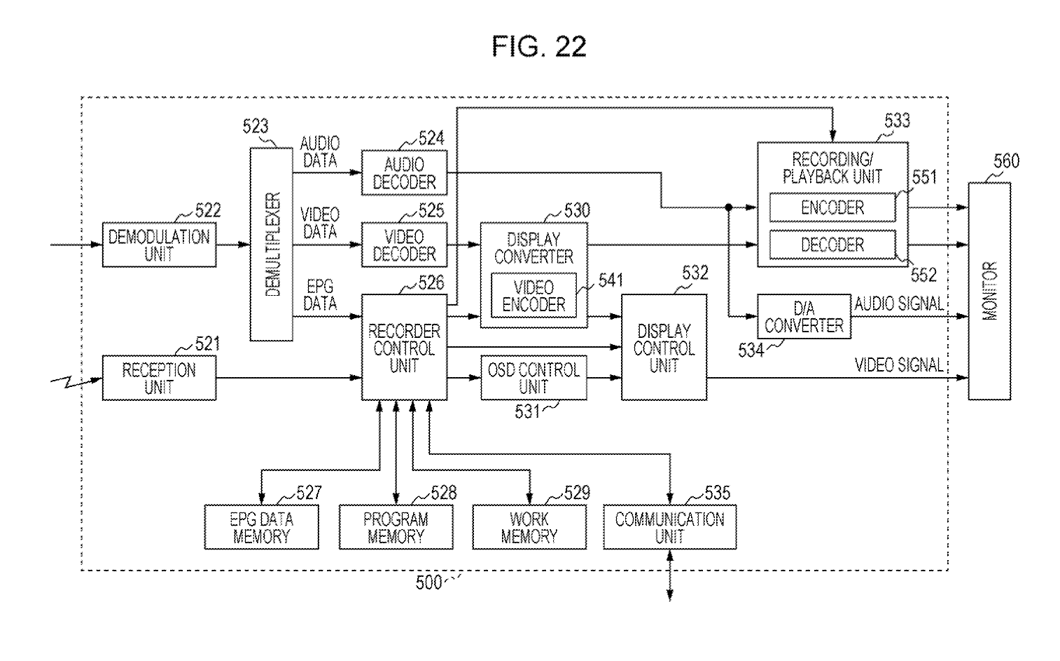

FIG. 22 is a block diagram illustrating a principal configuration example of a hard disk recorder which employs the image encoding device and image decoding device to which the present invention has been applied.

A hard disk recorder (HDD recorder) 500 shown in FIG. 22 is a device which stores, in a built-in hard disk, audio data and video data of a broadcast program included in broadcast wave signals (television signals) received by a tuner and transmitted from a satellite or a terrestrial antenna or the like, and provides the stored data to the user at timing according to the user's instructions.

The hard disk recorder 500 can extract audio data and video data from broadcast wave signals, decode these as appropriate, and store in the built-in hard disk, for example. Also, the hard disk recorder 500 can also obtain audio data and video data from another device via the network, decode these as appropriate, and store in the built-in hard disk, for example.

Further, the hard disk recorder 500 decodes audio data and video data recorded in the built-in hard disk, supplies to a monitor 560, and displays an image thereof on the screen of the monitor 560, for example. Also, the hard disk recorder 500 can output sound thereof from the speaker of the monitor 560.

The hard disk recorder 500 decodes audio data and video data extracted from the broadcast wave signals obtained via the tuner, or the audio data and video data obtained from another device via the network, supplies to the monitor 560, and displays an image thereof on the screen of the monitor 560, for example. Also, the hard disk recorder 500 can output sound thereof from the speaker of the monitor 560.

It goes without saying that operations other than these may be performed.

As shown in FIG. 22, the hard disk recorder 500 includes a reception unit 521, a demodulation unit 522, a demultiplexer 523, an audio decoder 524, a video decoder 525, and a recorder control unit 526. The hard disk recorder 500 further includes EPG data memory 527, program memory 528, work memory 529, a display converter 530, an OSD (On Screen Display) control unit 531, a display control unit 532, a recording/playback unit 533, a D/A converter 534, and a communication unit 535.

Also, the display converter 530 includes a video encoder 541. The recording/playback unit 533 includes an encoder 551 and a decoder 552.

The reception unit 521 receives the infrared signal from the remote controller (not shown), converts into an electrical signal, and outputs to the recorder control unit 526. The recorder control unit 526 is configured of, for example, a microprocessor and so forth, and executes various types of processing in accordance with the program stored in the program memory 528. At this time, the recorder control unit 526 uses the work memory 529 according to need.

The communication unit 535, which is connected to the network, performs communication processing with another device via the network. For example, the communication unit 535 is controlled by the recorder control unit 526 to communicate with a tuner (not shown), and to principally output a channel selection control signal to the tuner.

The demodulation unit 522 demodulates the signal supplied from the tuner, and outputs to the demultiplexer 523. The demultiplexer 523 separates the data supplied from the demodulation unit 522 into audio data, video data, and EPG data, and outputs to the audio decoder 524, video decoder 525, and recorder control unit 526, respectively.

The audio decoder 524 decodes the input audio data, for example, using the MPEG system, and outputs to the recording/playback unit 533. The video decoder 525 decodes the input video data, for example, using the MPEG system, and outputs to the display converter 530. The recorder control unit 526 supplies the input EPG data to the EPG data memory 527 for storing.

The display converter 530, encodes the video data supplied from the video decoder 525 or recorder control unit 526 into, for example, the video data conforming to the NTSC (National Television Standards Committee) system using the video encoder 541, and outputs to the recording/playback unit 533. Also, the display converter 530 converts the size of the screen of the video data supplied from the video decoder 525 or recorder control unit 526 into the size corresponding to the size of the monitor 560. The display converter 530 further converts the video data of which the screen size has been converted into the video data conforming to the NTSC system using the video encoder 541, converts into an analog signal, and outputs to the display control unit 532.

The display control unit 532 superimposes, under the control of the recorder control unit 526, the OSD signal output from the OSD (On Screen Display) control unit 531 on the video signal input from the display converter 530, and outputs to the display of the monitor 560 for display.

Also, the audio data output from the audio decoder 524 has been converted into an analog signal using the D/A converter 534, and supplied to the monitor 560. The monitor 560 outputs this audio signal from a built-in speaker.

The recording/playback unit 533 includes a hard disk as a storage medium in which video data, audio data, and so forth are recorded.

The recording/playback unit 533 encodes the audio data supplied from the audio decoder 524 by the encoder 551 using the MPEG system, for example. Also, the recording/playback unit 533 encodes the video data supplied from the video encoder 541 of the display converter 530 by the encoder 551 using the MPEG system. The recording/playback unit 533 synthesizes the encoded data of the audio data thereof, and the encoded data of the video data thereof using the multiplexer. The recording/playback unit 533 amplifies the synthesized data by channel coding, and writes the data thereof in the hard disk via a recording head.

The recording/playback unit 533 plays the data recorded in the hard disk via a playback head, amplifies, and separates into audio data and video data using the demultiplexer. The recording/playback unit 533 decodes the audio data, and video data by the decoder 552 using the MPEG system. The recording/playback unit 533 converts the decoded audio data from digital to analog, and outputs to the speaker of the monitor 560. Also, the recording/playback unit 533 converts the decoded video data from digital to analog, and outputs to the display of the monitor 560.

The recorder control unit 526 reads out the latest EPG data from the EPG data memory 527 based on the user's instructions indicated by the infrared signal from the remote controller which is received via the reception unit 521, and supplies to the OSD control unit 531. The OSD control unit 531 generates image data corresponding to the input EPG data, and outputs to the display control unit 532. The display control unit 532 outputs the video data input from the OSD control unit 531 to the display of the monitor 560 for display. Thus, EPG (Electronic Program Guide) is displayed on the display of the monitor 560.

Also, the hard disk recorder 500 can obtain various types of data such as video data, audio data, EPG data, and so forth supplied from another device via the network such as the Internet or the like.

The communication unit 535 is controlled by the recorder control unit 526 to obtain encoded data such as video data, audio data, EPG data, and so forth transmitted from another device via the network, and to supply this to the recorder control unit 526. The recorder control unit 526 supplies the encoded data of the obtained video data and audio data to the recording/playback unit 533, and stores in the hard disk, for example. At this time, the recorder control unit 526 and recording/playback unit 533 may perform processing such as re-encoding or the like according to need.

Also, the recorder control unit 526 decodes the encoded data of the obtained video data and audio data, and supplies the obtained video data to the display converter 530. The display converter 530 processes, in the same way as the video data supplied from the video decoder 525, the video data supplied from the recorder control unit 526, supplies to the monitor 560 via the display control unit 532 for displaying an image thereof.

Alternatively., an arrangement may be made wherein in accordance with this image display, the recorder control unit 526 supplies the decoded audio data to the monitor 560 via the D/A converter 534, and outputs audio thereof from the speaker.

Further, the recorder control unit 526 decodes the encoded data of the obtained EPG data, and supplies the decoded EPG data to the EPG data memory 527.

The hard disk recorder 500 thus configured employs the image decoding device 101 as the video decoder 525, decoder 552, and a decoder housed in the recorder control unit 526. Accordingly, the video decoder 525, decoder 552, and decoder housed in the recorder control unit 526 perform selection of the optimal direct mode for each object block (or macro block) using a decoded image in the same way as with the case of the image decoding device 101. Thus, increase in compressed information can be suppressed, and also prediction precision can be improved.

Accordingly, the hard disk recorder 500 can generate a prediction image with high precision. As a result thereof, the hard disk recorder 500 can obtain a decoded image with higher precision, for example, from the encoded data of video data received via the tuner, the encoded data of video data read out from the hard disk of the recording/playback unit 533, or the encoded data of video data obtained via the network, and display on the monitor 560.

Also, the hard disk recorder 500 employs the image encoding device 51 as the encoder 551. Accordingly, the encoder 551 performs selection of the optimal direct mode for each object block (or macro block) using a decoded image in the same way as with the case of the image encoding device 51. Thus, increase in compressed information can be suppressed, and also prediction precision can be improved.

Accordingly, the hard disk recorder 500 can improve the encoding efficiency of encoded data to be recorded in the hard disk, for example. As a result thereof, the hard disk recorder 500 can use the storage region of the hard disk in a more effective manner.

Note that description has been made so far regarding the hard disk recorder 500 for recording video data and audio data in the hard disk, but it goes without saying that any kind of recording medium may be employed. For example, even with a recorder to which a recording medium other than a hard disk, such as flash memory, optical disc, a video tape, or the like, is applied, in the same way as with the case of the above-mentioned hard disk recorder 500, the image encoding device 51 and image decoding device 101 can be applied thereto.

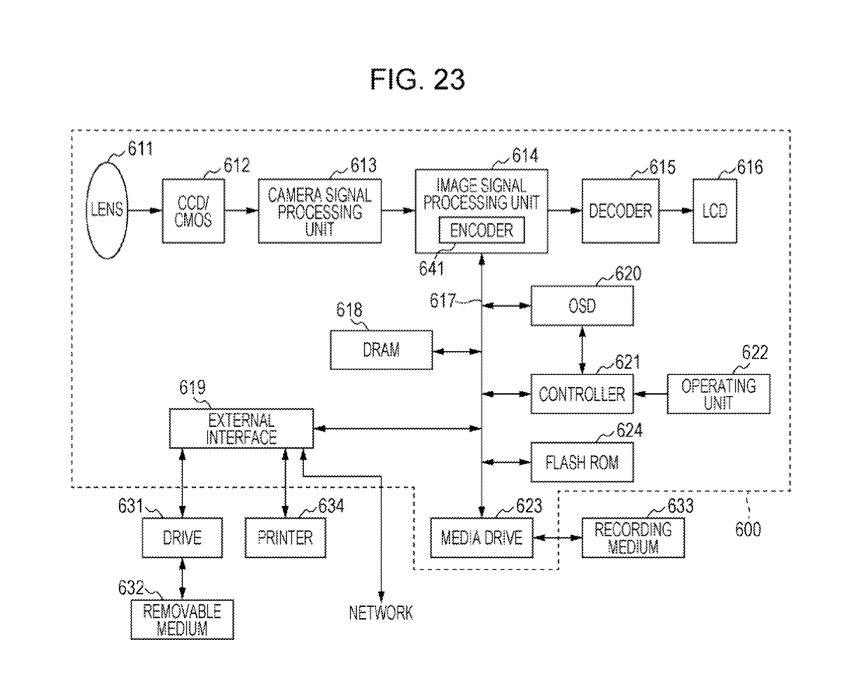

FIG. 23 is a block diagram illustrating a principal configuration example of a camera employing the image decoding device and image encoding device to which the present invention has been applied.

A camera 600 shown in FIG. 23 images a subject, displays an image of the subject on an LCD 616, and records this in a recording medium 633 as image data.

A lens block 611 inputs light (i.e., video of a subject) to a CCD/CMOS 612. The CCD/CMOS 612 is an image sensor employing a CCD or CMOS, converts the intensity of received light into an electrical signal, and supplies to a camera signal processing unit 613.

The camera signal processing unit 613 converts the electrical signal supplied from the CCD/CMOS 612 into color difference signals of Y, Cr, and Cb, and supplies to an image signal processing unit 614. The image signal processing unit 614 subjects, under the control of a controller 621, the image signal supplied from the camera signal processing unit 613 to predetermined image processing, or encodes the image signal thereof by an encoder 641 using the MPEG system for example. The image signal processing unit 614 supplies encoded data generated by encoding an image signal, to a decoder 615. Further, the image signal processing unit 614 obtains data for display generated at an on-screen display (OSD) 620, and supplies this to the decoder 615.

With the above-mentioned processing, the camera signal processing unit 613 takes advantage of DRAM (Dynamic Random Access Memory) 618 connected via a bus 617 to hold image data, encoded data encoded from the image data thereof, and so forth in the DRAM 618 thereof according to need.

The decoder 615 decodes the encoded data supplied from the image signal processing unit 614, and supplies obtained image data (decoded image data) to the LCD 616. Also, the decoder 615 supplies the data for display supplied from the image signal processing unit 614 to the LCD 616. The LCD 616 synthesizes the image of the decoded image data, and the image of the data for display, supplied from the decoder 615 as appropriate, and displays a synthesizing image thereof.

The on-screen display 620 outputs, under the control of the controller 621, data for display such as a menu screen or icon or the like made up of a symbol, characters, or a figure to the image signal processing unit 614 via the bus 617.

Based on a signal indicating the content commanded by the user using an operating unit 622, the controller 621 executes various types of processing, and also controls the image signal processing unit 614, DRAM 618, external interface 619, on-screen display 620, media drive 623, and so forth via the bus 617. A program, data, and so forth necessary for the controller 621 executing various types of processing are stored in FLASH ROM 624.

For example, the controller 621 can encode image data stored in the DRAM 618, or decode encoded data stored in the DRAM 618 instead of the image signal processing unit 614 and decoder 615. At this time, the controller 621 may perform encoding and decoding processing using the same system as the encoding and decoding system of the image signal processing unit 614 and decoder 615, or may perform encoding and decoding processing using a system that neither the image signal processing unit 614 nor the decoder 615 can handle.

Also, for example, in the event that start of image printing has been instructed from the operating unit 622, the controller 621 reads out image data from the DRAM 618, and supplies this to a printer 634 connected to the external interface 619 via the bus 617 for printing.

Further, for example, in the event that image recording has been instructed from the operating unit 622, the controller 621 reads out encoded data from the DRAM 618, and supplies this to a recording medium 633 mounted on the media drive 623 via the bus 617 for storing.

The recording medium 633 is an optional readable/writable removable medium, for example, such as a magnetic disk, a magneto-optical disk, an optical disc, semiconductor memory, or the like. It goes without saying that the recording medium 633 is also optional regarding the type of a removable medium, and accordingly may be a tape device, or may be a disc, or may be a memory card. It goes without saying that the recoding medium 633 may be a non-contact IC card or the like.

Alternatively, the media drive 623 and the recording medium 633 may be configured so as to be integrated into a non-transportable recording medium, for example, such as a built-in hard disk drive; SSD (Solid State Drive), or the like.

The external interface 619 is configured of, for example, a, USB input/output terminal and so forth, and is connected to the printer 634 in the event of performing printing of images. Also, a drive 631 is connected to the external interface 619 according to need, on which the removable medium 632 such as a magnetic disk, optical disc, or magneto-optical disk or the like is mounted as appropriate, and a computer program read out therefrom is installed in the FLASH ROM 624 according to need.

Further, the external interface 619 includes a network interface to be connected to a predetermined network such as a LAN, the Internet, or the like. For example, in accordance with the instructions from the operating unit 622, the controller 621 can read out encoded data from the DRAM 618, and supply this from the external interface 619 to another device connected via the network. Also, the controller 621 can obtain, via the external interface 619, encoded data or image data supplied from another device via the network, and hold this in the DRAM 618, or supply this the image signal processing unit 614.

The camera 600 thus configured employs the image decoding device 101 as the decoder 615. Accordingly, the decoder 615 performs selection of the optimal direct mode for each object block (or macro block) using a decoded image in the same way as with the case of the image decoding device 101. Thus, increase in compressed information can be suppressed, and also prediction precision can be improved.

Accordingly, the camera 600 can generate a prediction image with high precision. As a result thereof, the camera 600 can obtain a decoded image with higher precision, for example, from the image data generated at the CCD/CMOS 612, the encoded data of video data read out from the DRAM 618 or recording medium 633, or the encoded data of video data obtained via the network, and display on the LCD 616.

Also, the camera 600 employs the image encoding device 51 as the encoder 641. Accordingly, the encoder 641 performs selection of the optimal direct mode for each object block (or macro block) using a decoded image in the same way as with the case of the image encoding device 51. Thus, increase in compressed information can be suppressed, and also prediction precision can be improved.

Accordingly, the camera 600 can improve encoding efficiency of encoded data to be recorded in the hard disk, for example. As a result thereof, the camera 600 can use the storage region of the DRAM 618 or recording medium 633 in a more effective manner.

Note that the decoding method of the image decoding device 101 may be applied to the decoding processing that the controller 621 performs. Similarly, the encoding method of the image encoding device 51 may be applied to the encoding processing that the controller 621 performs.

Also, the image data that the camera 600 images may be a moving image, or may be a still image.

It goes without saying that the image encoding device 51 and image decoding device 101 may be applied to a device or system other than the above-mentioned devices.

### REFERENCE SIGNS LIST

51 image encoding device, 66 lossless encoding unit, intra prediction unit, 75 motion prediction/compensation unit, 76 direct mode selecting unit, 77 prediction image selecting unit, 81 SDM motion vector calculating unit, 82 TDM motion vector calculating-unit, 91 SDM residual energy calculating unit, 92 TDM residual energy calculating unit, 93 comparing unit, 94 direct mode determining unit, 112 lossless decoding unit, 121 intra prediction unit, 122 motion prediction/compensation unit, 123 direct mode selecting unit, 124 switch

1. An image processing device comprising:
spatial mode residual energy calculating means configured to use motion vector information according to a spatial direct mode of an object block to calculate spatial mode residual energy that employs a peripheral pixel adjacent to said object block in a predetermined positional relation and also included in a decoded image;
temporal mode residual energy calculating means configured to use motion vector information according to a temporal direct mode of said object block to calculate temporal mode residual energy that employs said peripheral pixel; and
direct mode determining means configured to determine to perform encoding of said object block in said spatial direct mode in the event that said spatial mode residual energy calculated by said spatial mode residual energy calculating means is equal to or smaller than said temporal mode residual energy calculated by said temporal mode residual energy calculating means, and to perform encoding of said object block in said temporal direct mode in the event that said spatial mode residual energy is greater than said temporal mode residual energy.

2. The image processing device according to claim 1, further comprising:
encoding means configured to encode said object block in accordance with said spatial direct mode or said temporal direct mode determined by said direct mode determining means.

3. The image processing device according to claim 1, wherein said spatial mode residual energy calculating means calculate said spatial mode residual energy from a Y signal component, a Cb signal component, and a Cr signal component;
and wherein said temporal mode residual energy calculating means calculate said temporal mode residual energy from a Y signal component, a Cb signal component, and a Cr signal component;
and wherein said direct mode determining means compare a magnitude relation between said spatial mode residual energy and said temporal mode residual energy for each of said Y signal component, said Cb signal component, and said Cr signal component to determine whether said object block is encoded in said spatial direct mode or said object block is encoded in said temporal direct mode.

4. The image processing device according to claim 1, wherein said spatial mode residual energy calculating means calculate said spatial mode residual energy from a luminance signal component of said object block;
and wherein said temporal mode residual energy calculating means calculate said temporal mode residual energy from a luminance signal component of said object block.

5. The image processing device according to claim 1, wherein said spatial mode residual energy, calculating means calculate said spatial mode residual energy from a luminance signal component and a color difference signal component of said object block;
and wherein said temporal mode residual energy calculating means calculate said temporal mode residual energy from a luminance signal component and a color difference signal component of said object block.

6. The image processing device according to claim 1, further comprising:
spatial mode motion vector calculating means configured to calculate motion vector information according to said spatial direct mode; and
temporal mode motion vector calculating means configured to calculate motion vector information according to said temporal direct mode.

7. An image processing method comprising the step of:
causing an image processing device
to use motion vector information according to a spatial direct mode of an object block to calculate spatial mode residual energy that employs a peripheral pixel adjacent to said object block in a predetermined positional relation and also included in a decoded image;
to use motion vector information according to a temporal direct mode of said object block to calculate temporal mode residual energy that employs said peripheral pixel; and
to determine to perform encoding of said object block in said spatial direct mode in the event that said spatial mode residual energy is equal to or smaller than said temporal mode residual energy, and to perform encoding of said object block in said temporal direct mode in the event that said spatial mode residual energy is greater than said temporal mode residual energy.

8. An image processing device comprising:
spatial mode residual energy calculating means configured to use motion vector information according to a spatial direct mode of an object block encoded in a direct mode to calculate spatial mode residual energy that employs a peripheral pixel adjacent to said object block in a predetermined positional relation and also included in a decoded image;
temporal mode residual energy calculating means configured to use motion vector information according to a temporal direct mode of said object block to calculate temporal mode residual energy that employs said peripheral pixel; and
direct mode determining means configured to determine to perform generation of a prediction image of said object block in said spatial direct mode in the event that said spatial mode residual energy calculated by said spatial mode residual energy calculating means is equal to or smaller than said temporal mode residual energy calculated by said temporal mode residual energy calculating means, and to perform generation of a prediction image of said object block in said temporal direct mode in the event that said spatial mode residual energy is greater than said temporal mode residual energy.

9. The processing device according to claim 8, further comprising:
motion compensating means configured to generate a prediction image of said object block in accordance with said spatial direct mode or said temporal direct mode determined by said direct mode determining means.

10. The processing device according to claim 8, wherein said spatial mode residual energy calculating means calculate said spatial mode residual energy from a Y signal component, a Cb signal component, and a Cr signal component;
and wherein said temporal mode residual energy calculating means calculate said temporal mode residual energy from a Y signal component, a Cb signal component, and a Cr signal component;
and wherein said direct mode determining means compare a magnitude relation between said spatial mode residual energy and said temporal mode residual energy for each of said Y signal component, said Cb signal component, and said Cr signal component to determine whether generation of a prediction image of said object block is performed in said spatial direct mode or generation of a prediction image of said object block is performed in said temporal direct mode.

11. The processing device according to claim 8, wherein said spatial mode residual energy calculating means calculate said spatial mode residual energy from a luminance signal component of said object block;
and wherein said temporal mode residual energy calculating means calculate said temporal mode residual energy from a luminance signal component of said object block.

12. The processing device according to claim 8, wherein said spatial mode residual energy calculating means calculate said spatial mode residual energy from a luminance signal component and a color difference signal component of said object block;
and wherein said temporal mode residual energy calculating means calculate said temporal mode residual energy from luminance signal component and a color difference signal component of said object block.

13. The processing device according to claim 8, further comprising:
spatial mode motion vector calculating means configured to calculate motion vector information according to said spatial direct mode; and
temporal mode motion vector calculating means configured to calculate motion vector information according to said temporal direct mode.

14. An image processing method comprising the step of:
causing an image processing device
to use motion vector information according to a spatial direct mode of an object block encoded in a direct mode to calculate spatial mode residual energy that employs a peripheral pixel adjacent to said object block in a predetermined positional relation and also included in a decoded image;
to use motion vector information according to a temporal direct mode of said object block to calculate temporal mode residual energy that employs said peripheral pixel; and
to determine to perform generation of a prediction image of said object block in said spatial direct mode in the event that said spatial mode residual energy is equal to or smaller than said temporal mode residual energy, and to perform generation of a prediction image of said object block in said temporal direct mode in the event that said spatial mode residual energy is greater than said temporal mode residual energy.
